(19) United States
(12) Patent Application Publication
(10) Pub. No.: US 2010/0103127 A1
(43) Pub. Date: Apr. 29, 2010

(54) Virtual Keyboard Input System Using Pointing Apparatus In Digital Device

(76) Inventors: Taeun Park, Seoul (KR); Sangjung Shim, Seoul (KR)

Correspondence Address: ST. ONGE STEWARD JOHNSTON & REENS, LLC, 986 BEDFORD STREET, STAMFORD, CT, 06905-5619, US

(21) Appl. No.: 12/546,393

(22) Filed: Aug. 24, 2009

Related U.S. Application Data
(63) Continuation of application No. PCT/KR2008/001089, filed on Feb. 25, 2008.

(30) Foreign Application Priority Data
Feb. 23, 2007 (KR) 10-2007-0018127
Sep. 10, 2007 (KR) 10-2007-0091824
Dec. 10, 2007 (KR) 10-2007-0127267

(51) Int. Cl. G06F 3/041

(52) U.S. Cl. 345/173

(57) ABSTRACT

A virtual keyboard input system using a pointing device in a digital device. The virtual keyboard input system includes: a sensor unit sensing a contact and a two-dimensional contact position; a switch unit; and a control unit dividing a contact sensitive region of the sensor unit into multiple division regions according to XY coordinates, assigning virtual keys of a virtual keyboard to the division regions, and when the switch unit is turned on, controlling an input of information for a virtual key assigned to a division region which is contacted among the division regions.

### CROSS-REFERENCE TO RELATED APPLICATIONS

The present application is a continuation of pending International patent application PCT/KR2008/001089 filed on Feb. 25, 2008 which designates the United States and claims priority from Korean patent application Nos. 10-2007-0018127 filed Feb. 23, 2007, 10-2007-0091824 filed Sep. 10, 2007 and 10-2007-0127267 filed Dec. 10, 2007. All prior applications are herein incorporated by reference in their entirety.

### FIELD OF THE INVENTION

### Technical Field

The present invention relates to a virtual keyboard input system using a pointing device in a digital device, and more particularly, to a virtual keyboard input system that sets a virtual keyboard using an absolute coordinate system to a two-dimensional pointing device, such as a touchpad or a touchscreen, and inputs letters by using the two-dimensional pointing device.

### BACKGROUND OF THE INVENTION

Computers can be used with the graphical user interface (GUI) systems via a mouse that can move a pointer that points to commands and indicates the position on a computer monitor.

As the size of computers has become smaller nowadays, touchpads and pointing sticks have been developed as built-in pointing devices to replace the mouse and improve user convenience.

Current portable digital devices, such as personal digital assistants (PDAs), portable multimedia players (PMPs), and even cellular phones, are becoming more like computers.

However, such digital devices are too small to have a pointing device, and thus are configured as user interface (UI) systems using a screen touch method or at least the cellular phones are operated using a keypad by which letters can be input.

Accordingly, portable digital devices having a UI function like a notebook personal computer (PC) having an embedded pointing device have not been developed yet because of their small size. In particular, cellular phones which should allow numbers to be input are generally too small to have a pointing device, such as a touchpad, a pointing stick, or a trackball, and even though they have a pointing device, the pointing device just helps to more easily input numbers. Accordingly, the cellular phones have a keypad-oriented configuration.

### Technical Problem

The present invention provides a virtual keyboard input system that can input letters, numbers, and so on by using a virtual keyboard alongside a two-dimensional pointing device.

### SUMMARY OF THE INVENTION

### Technical Solution

According to an aspect of the present invention, there is provided a virtual keyboard input system using a pointing device in a digital device. The virtual keyboard input system comprises: a sensor unit sensing a contact and a two-dimensional contact position; a switch unit; and a control unit dividing a contact sensitive region of the sensor unit into multiple division regions according to XY coordinates, assigning virtual keys of a virtual keyboard to the division regions, and when the switch unit is turned on, controlling an input of information for a virtual key assigned to a division region which is contacted among the division regions.

The switch unit may comprise a first switch unit coupled with the first sensor unit to input the first virtual key set and a second switch unit coupled with the second sensor unit to input the second virtual key set. The switch unit may use a mechanical switch that is turned on by pressing. The sensor unit may be pressed by a user to a predetermined depth, and the switch unit may be disposed adjacent to the sensor unit and may also be pressed when the sensor unit is pressed.

The sensor unit may sense the contact and the contact position by using a change in electrostatic capacity due to contact.

The switch unit may be disposed at an edge of a surface opposite to a surface of the digital device where the sensor unit is disposed, such that when a user holds the digital device in one hand and contacts the sensor unit with the thumb, the switch unit can be pressed with other fingers than the thumb.

The switch unit may comprise: a lower switch unit disposed on a top surface of the sensor unit and including a group of lines that are arranged in parallel in a first axis; and an upper switch unit spaced apart from the lower switch unit and including a group of lines that are arranged in parallel in a second axis different from the first axis and contact the first lines of the lower switch unit due to a downward pressure, wherein the switch unit detects a pressing by determining whether current flows when the lower switch unit and the upper switch unit contact each other. The lines of the lower switch unit may include negative power lines connected to a negative electrode, and positive power lines connected to a positive electrode, which are alternately arranged, wherein the second lines of the upper switch unit are conductive lines with no connection with power source.

A switch used in the switch unit may be turned on or off in accordance with a change in electrostatic capacity.

Uneven members may be formed as a guiding element on a surface of the sensor unit so as for a user to distinguish the division regions. At least a central row or column of division regions may be larger than that of other division areas so as for a user to easily recognize the path through which the user's thumb travels.

The control unit may control information of a virtual key assigned to a division region which is contacted among the division regions to be displayed on a screen of the digital device.

When a division region among the division regions of the sensing unit is contacted, the control unit may make the division region to be expanded to have a greater area than that before being contacted.

When a switch-on time for which the switch unit is turned on is less than a preset time interval, the control unit makes primary information assigned to the virtual key is input while if the switch-on time is greater than the preset time interval a secondary information which is different from the primary information is to be input. For example, an additional operation such as pressing shift key or space key which is needed before or after a text input operation may be omitted since the longer pressing may assume that the virtual key is pressed in the state where a shift key is pressed, or there follows a space key pressing.

A position of each of the division regions may be calibrated in accordance with a center position of the contacting area of a finger with the division region.

According to another aspect of the present invention, there is provided a virtual keyboard input system using a pointing device in a digital device, the virtual keyboard input system comprising: a sensor unit sensing a contact and a two-dimensional contact position in accordance with a change in electrostatic capacity and calculating a contact pressure according to the change in the electrostatic capacity; and a control unit sensing region of the sensor unit into multiple division regions according to XY coordinates, assigning virtual keys of a virtual keyboard to the division regions, and making information of a virtual key assigned to a division region that is contacted be input when the calculated contact pressure is greater than a pressing reference pressure.

The control unit may make information of a virtual key assigned to a division region that is contacted while the contact pressure exceeds a pressing threshold pressure, be input, when the contact pressure exceeds the pressing reference pressure, and when a contact position, contacted when the contact pressure exceeds the pressing reference pressure, is different from a contact position, contacted when the contact pressure exceeds the pressing threshold pressure, wherein the pressing threshold pressure is a pressure between the pressing reference pressure and a touch pressure by which a touch is identified.

The pressing reference pressure may be set variably depending on a contact position. In a first mode for the right-handed, the pressing reference pressure for a left upper region of the sensor unit may be set to be higher than the pressing reference pressure for a right lower region of the sensor unit.

### ADVANTAGEOUS EFFECTS

According to the present invention, since a virtual keyboard along with a two-dimensional pointing device, such as a touchpad, is used, both pointing and text input functions can be performed by one device, thereby reducing the size of a digital device. The digital device according to the present invention becomes small but allows more convenient and accurate text input than a digital device using a conventional keypad.

In principle, a virtual keyboard input system according to the present invention can use any of an electrostatic capacity-based method, a resistance-based method, a frequency-based method, and so on, which can provide a coordinate system and a pointing function.

Currently, in order to replace keypads of cellular phones or keyboards, touchscreens have been developed as pointing devices. However, since command button or a menu item on a touchscreen is handled by a finger, buttons or menu items should be large enough to prevent ambiguous point of contact by a finger. Accordingly, touchscreens have a limitation in reducing the size of a digital device.

However, the virtual keyboard input system according to the present invention can be smaller than a system using a conventional touchscreen since, even though a finger touches several buttons or menu items on a touchpad, the touchpad calculates the position of the finger, which is indicated by a pointer on a screen, as one point.

As described above, even though a region corresponding to each key is much smaller than a thumb and a finger touches several keys at once, it does not matter for the virtual keyboard input system according to the present invention.

Due to this fact, with a pressure sensing device used as an input device for a portable digital device, there is a limitation in reducing the size of the portable digital device, since command buttons or menu items corresponding to respective commands to be executed should be large enough to be distinguished by a finger. Accordingly, an input device for a digital device which can be held and operated in one hand has not been developed yet, but the virtual keyboard input system according to the present invention can be held and operated in one hand.

Accordingly, a user using a cellular phone to which the virtual keyboard input system according to the present invention is applied can be free from problems that a conventional QWERTY phone brings forth. That is, in the case of a QWERTY phone, a user should raise his/her thumb to reduce a contact area with a keypad, select a target key, and carefully press the target key not to press other keys around the target key, thereby leading to stress and fatigue in the thumb and inconvenience in use.

However, in the case of the virtual keyboard input system using the touchpad according to the present invention, there is no need to carefully move a finger in order to distinguish a target key from other keys on a keyboard, thereby ensuring fast text input without fatigue.

Accordingly, since a virtual keyboard of the virtual keyboard input system according to the present invention can be easily used in a small space, a cellular phone employing the virtual keyboard input system is no longer a simple voice telecommunication tool but rather may act as a fingertop computer upgraded from a personal digital assistant (PDA) that is a palmtop computer.

This means that a user can carry a digital device anywhere anytime in ubiquitous computing environment. The virtual keyboard input system using the touchpad according to the present invention can be applied to a remote controller having a text input function used in a television (TV), a video cassette recorder (VCR), and a digital versatile disk (DVD) as well as to a portable digital electronic device.

That is, since not only a simple pointing function but also a text input function are performed, an electronic device having a monitor can have a graphical user interface (GUI). Ultimately, the virtual keyboard input device according to the present invention can be a hand-in ubiquitous input system that enables an electronic device to be computerized and all electronic devices to be networked.

### BRIEF DESCRIPTION OF THE DRAWINGS

FIG. 1 is a block diagram of a virtual keyboard input system according to an embodiment of the present invention.

FIGS. 2 and 3 are cross-sectional views illustrating a mechanical switch used in a switch unit, disposed adjacent to a touchpad, and pressed when the touchpad s pressed.

FIG. 4 is a cross-sectional view illustrating dome switches disposed underneath a touchpad.

FIG. 5A illustrates a method of attaching a switch serving as a function button of a touchpad to the top surface of a touchpad.

FIG. 5B illustrates the arrangement of lines.

FIG. 5C illustrates a switch circuit being shorted when a touchpad is pressed and switches are accordingly pressed.

FIGS. 6A-6D illustrate a touchpad and an input switch separated from each other.

FIGS. 7A and 7B illustrate the input switch pressed when the touchpad is pressed similarly to FIGS. 2 through 5.

FIGS. 7C and 7D illustrate a cellular phone having a keypad.

FIGS. 7E and 7F illustrate the touchpad being pressed to perform a touchpad function and an input switch function.

FIGS. 8A-8B illustrate a virtual keyboard input system including two sensor units (touchpads) according to an embodiment of the present invention.

FIGS. 9 through 11C illustrate the virtual keyboard input system of FIGS. 8A-8B used in different modes.

FIGS. 12A-12B are a cross-sectional view of touchpads and illustrates the arrangement of function buttons coupled to the touchpads.

FIGS. 13A-13H illustrate switches disposed on both upper and lower ends of a rear surface of a cellular phone and performing the function of dome switches.

FIGS. 14A through 19D illustrate digital devices employing a virtual keyboard input system according to embodiments of the present invention.

FIGS. 20A through 21B illustrate a digital device having two touchpads on which uneven members are formed to distinguish division regions.

FIGS. 22A through 23 are views for explaining a method of inputting letters when division regions of two touchpads have uniform areas according to an embodiment of the present invention.

FIGS. 24A through 25 are views for explaining a method of inputting letters when division regions of two touchpads have different areas according to an embodiment of the present invention.

FIGS. 26A-26E are a view for explaining a method of operating a cellular phone having the touchpads of FIG. 22A-22B for the call mode in the portrait mode.

FIGS. 27A-27B illustrate a coordinate system of the touchpad of FIGS. 24A-24B used in a vertical mode.

FIG. 28 is a flow chart of a method of calculating coordinates of a cursor.

FIG. 29 illustrates a method of displaying cursors on a screen by using signals from two touchpads according to an embodiment of the present invention.

FIGS. 30A-30G are a view for explaining a method of calibrating a mismatch between the center of contact area and the reference point of the touchpad when user's finger is placed on the reference point.

FIG. 31 is a block diagram of a virtual keyboard input system according to another embodiment of the present invention.

FIGS. 32A-32C illustrate three types of pressure change which occur when a finger contacts the touchpad to carry other functions than the pointing function of the touchpad.

FIGS. 33A-33B illustrate available regions for tapping in touchpads having a tapping function of FIG. 32A-32C.

FIGS. 34A-34D illustrate an error which may arise when a touchpad works as a button on the basis of the pressure change during a pressing operation.

FIG. 35 is a flowchart illustrating a method of correcting letters according to an embodiment of the present invention.

FIGS. 36A-36D are a view for explaining a method of performing a function or inputting when there is a certain pattern of finger movement on the touchpad within a predetermined time.

FIG. 37 is a flowchart illustrating a method of initializing a touchpad which is necessary for the touchpad to do the function of a function button.

FIG. 38 illustrates contact areas between a finger and a sensor unit on several positions of the touchpad.

FIG. 39 illustrates a contact pressure versus a pressing pressure at each position when a touchpad is held as shown in FIG. 38.

FIG. 40 is a flowchart illustrating a method of setting a pressing reference pressure at each division region according to an embodiment of the present invention.

FIG. 41 illustrates a method of defining each key region of a virtual keyboard, wherein once a key is selected, the region corresponding to the key is expanded.

### DETAILED DESCRIPTION OF THE INVENTION

### Best Mode

The present invention realizes a virtual keyboard alongside a two-dimensional pointing device, controls the position of a pointer in a relative coordinate system when an original pointing function of the pointing device is performed, and inputs letters into the virtual keyboard in an absolute coordinate system when a text input function is performed.

A virtual keyboard input system according to the present invention can be used as an input device for a conventional desktop computer. But its main use is for a portable digital device, such as a cellular phone, a personal digital assistant (PDA), or a remote controller, to input letters, numbers, and so on.

FIG. 1 is a block diagram of a virtual keyboard input system using a pointing device according to an embodiment of the present invention.

Referring to FIG. 1, the virtual keyboard input system includes a sensor unit 110, a switch unit 120, and a control unit 130.

The sensor unit 110 senses a contact occurrence and a contact position according to a change in electrostatic capacity.

The sensor unit 110 may be a general touchpad, a touchscreen, or the like.

When the sensor unit 110 is a touchpad, the sensor unit 110 detects whether there is a contact by detecting a change in electrostatic capacity which arises when a user's finger touches the sensor unit 110, and the sensor unit 110 detects the position of the finger by using the point where the change in the electrostatic capacity occurs. Such a method of detecting a contact occurrence and a contact position according to a change in electrostatic capacity is already known widely, and thus a detailed explanation thereof will not be given.

When the sensor unit 110 is a touchscreen, the sensor unit 110 may detect a contact occurrence and a contact position in the same manner as that used when the sensor unit 110 is a touchpad. However, in general, since two groups of lines connected to a positive power source and connected to a negative power source are alternately arranged on a screen in parallel and over these lines another group of conductive lines are arranged perpendicular to the group of lines connected to the negative and positive power sources. When a user presses the screen, the conductive lines arranged across the lines connected to the negative and positive power sources, thereby results in short-circuit and changes the resistance. Accordingly, the sensor unit 110 detects a contact and a contact position by using a point where the shortcircuit bringing the resistance change is caused.

Such a method of detecting a contact occurrence and a contact position according to a change in resistance on a touchscreen or the like is also already known widely, and thus a detailed explanation thereof will not be given.

The switching unit 120 performs a function of a function button for a mouse in a pointing mode and performs a text input function in a text input mode in which letters, numbers, and so on are input.

A switch of the switch unit 120 used to determine an on or off state may be a mechanical switch, an electronic switch, which determines an on or off state by using a contact occurrence like a touchpad or a touchscreen, or a piezoelectric switch, which senses a pressure and generates a signal when sensing a pressure.

The control unit 130 divides a contact sensing region of the sensor unit 110 into a multiple division regions according to XY coordinates, assigns a virtual key of a virtual keyboard to each division region, and when the switch unit 120 is turned on, controls information of a virtual key assigned to a division region that is contacted by a finger to be input.

That is, the control unit 130 sets a position of each of virtual keys constituting the virtual keyboard to the sensor unit 110 and, when there is a contact on the position and the switch unit 120 is turned on, makes a letter or the like for the virtual key corresponding to the position to be input.

Also, the control unit 130 may display the arrangement of a virtual keyboard comprising a virtual key set assigned to the sensor unit 110 on a screen of a digital device, and indicate a virtual key assigned to a position, which is contacted, of the sensor unit

110 on the virtual keyboard or in a separate location of the screen from the virtual keyboard.

A digital device, such as a cellular phone or a personal digital assistant (PDA), which has its own output window physically connected to the sensor unit 110, may display the virtual keyboard on the output window, and a digital device, such as a television (TV) remote controller, which does not have its own output window wired to the sensor unit 110, may display the virtual keyboard on a screen of a TV that wirelessly communicates.

When the sensor unit 110 is a touchpad, a currently selected virtual key can be indicated on the virtual keyboard displayed on the screen. However, when the sensor unit 110 is a touchscreen, a currently selected virtual key displayed on the virtual keyboard may be covered by a finger and thus it is preferred that the currently selected virtual key be displayed on another location separate from the virtual keyboard.

Also, even when the sensor unit 110 is a touchpad, in order to prevent the screen from being occupied by the virtual keyboard and save a space for other contents to be displayed, the virtual keyboard may not be displayed and only information for the currently selected virtual key may be displayed on a extra text-cursor supported area or a predetermined position on the screen.

The function of each element will be explained in detail with other drawings. Since a touchpad is a representative sensor unit, the touchpad will be exemplarily explained but the present invention is applicable to other devices having a pointing function such as a touchscreen.

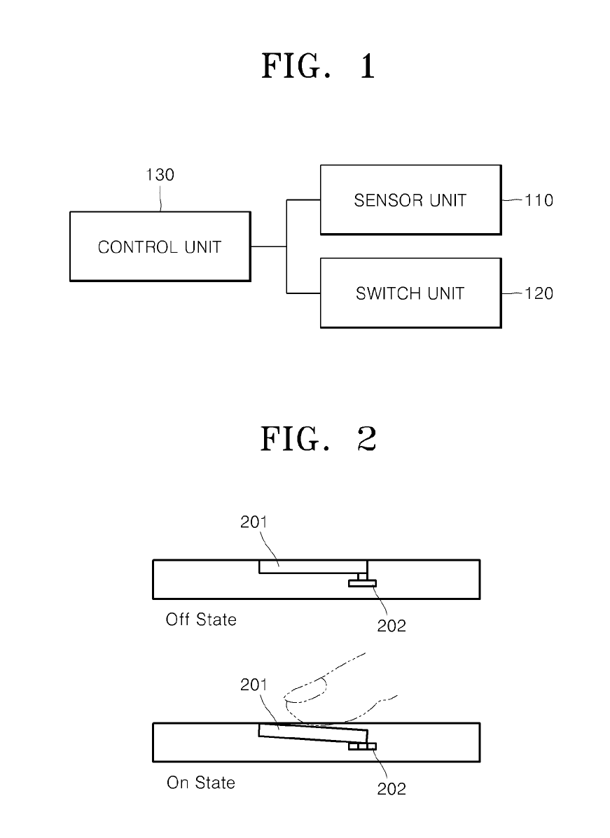

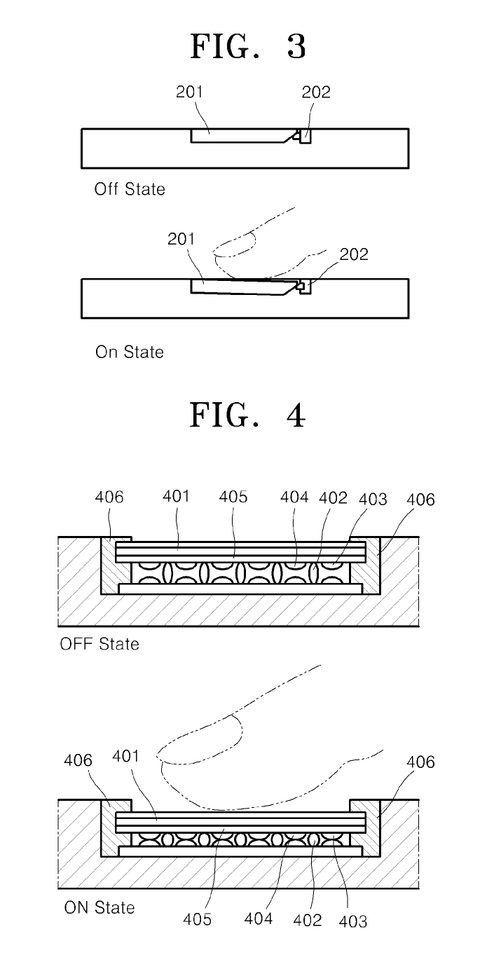

FIGS. 2 and 3 illustrate a mechanical switch 202 used in the switch unit 120, disposed adjacent to a touchpad 201, and pressed as the touchpad 201 is pressed.

The touchpad body 201 is pressed by a user like a lever which accordingly presses the switch 202. Referring to FIG. 2, the switch 202 is disposed on an end of a lower portion of the touchpad 201 and pressed when the touchpad 201 is pressed. Referring to FIG. 3, the switch 202 is disposed beside the touchpad 201 and laterally pressed when the touchpad 201 is pressed.

FIG. 4 illustrates dome switches 403 disposed under a bottom surface of a touchpad 401. Since an insulating layer 402 covers and protects electrodes, other electronic parts, and electric circuits mounted on the bottom surface of the touchpad 401 and an elastic spacer 405, 406 surrounds the touchpad 401, the touchpad 401 can be vertically moved and there exists no gap between the touchpad 401 and the cellular phone even when the touchpad 401 is pressed by a finger.

Since bottom surface member 404 is fixed, the dome switches 403 change from an off state to an on state when the touchpad 401 is pressed. The dome switches 403 may be arranged on an edge or on a central portion of the touchpad 401. The number and positions of the dome switches 403 may be determined so as for a user not to apply an excessive force to operate the touchpad 401.

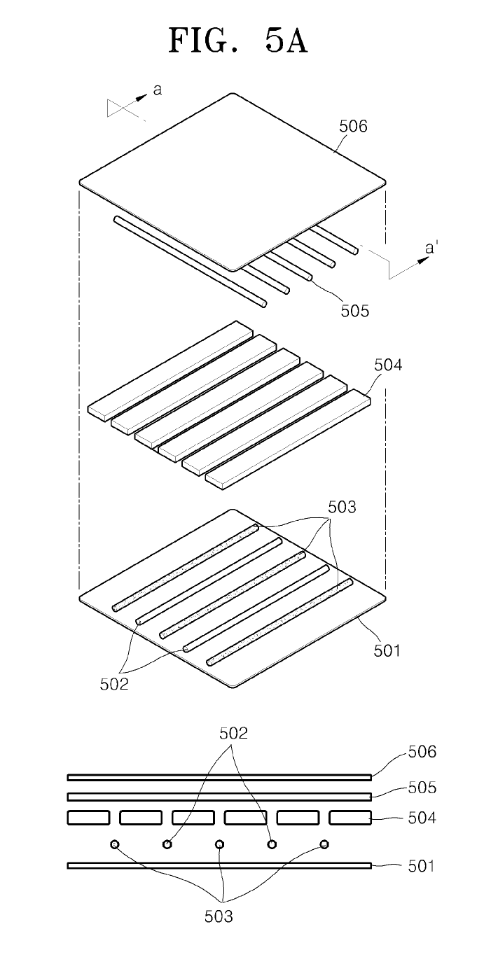

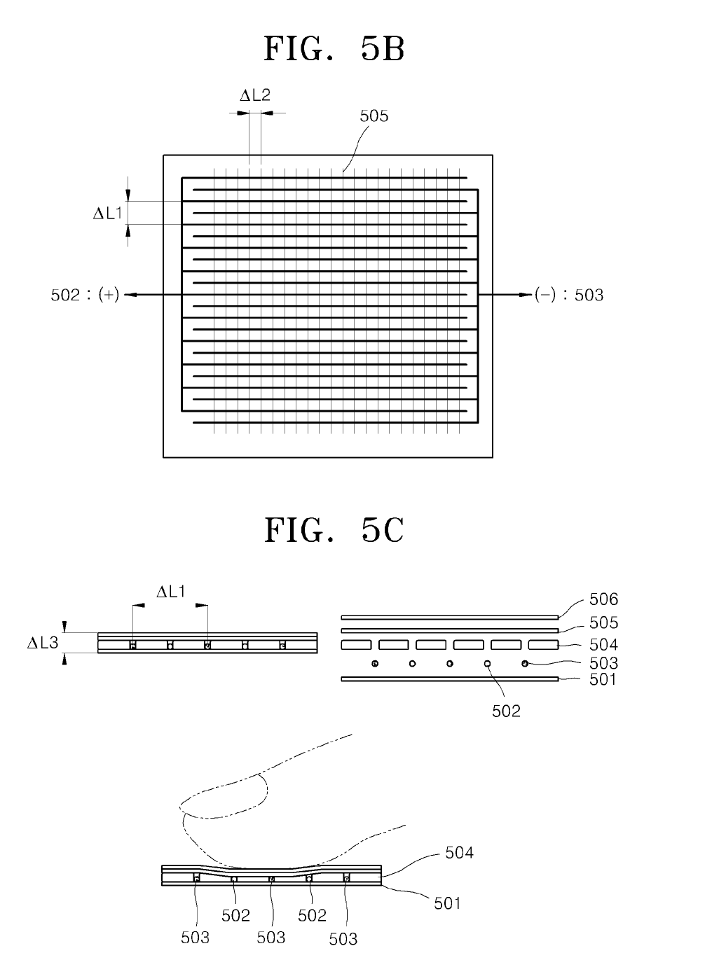

FIG. 5A illustrates a method of attaching the switch unit 120 to the top surface of the sensor unit 110. FIG. 5B illustrates the arrangement of lines. FIG. 5C illustrates a switch circuit before and after the touchpad is pressed and the switch unit 120 is accordingly turns to a shorted state when pressed.

When the sensor unit 110 is a touchpad that senses a contact position from a change in electrostatic capacity, even though a user's finger and a surface of the touchpad do not directly contact each other, electrostatic capacity may be changed. Accordingly, the switch unit 120 may be installed on the top surface of the sensor unit 110 as shown in FIG. 39.

In detail, the switch unit 120 of FIG. 5 is disposed on the top surface of the sensor unit 110 and performs a switching function when an upper switch unit and a lower switch unit disposed on the bottom surface 501 contact each other. The lower switch unit includes a group of lines including negative power lines 503 connected to a cathode and positive power lines 502 connected to an anode alternately arranged in parallel in a first axis. The upper switch unit includes multiple lines arranged in parallel in a second axis perpendicular to the first axis.

In detail, the bottom surface 501 of the switch unit 120 contacting the sensor unit 110 and a top surface 506 of the switch unit 120 exposed to the outside are formed of an insulating film, such as a polyester film, having durability and flexibility, and insulate conductive lines.

The first group of lines including the negative power lines 503 and the positive power lines 502 are connected to power sources of opposite charge. For example, the negative power lines 503 may be connected to a ground electrode, and the positive power lines 502 may be connected to a 5V electrode.

Conductive lines used as the first group lines may be attached to the bottom surface 501 formed of an insulating film to a thickness of 0.1 to 0.3 mm at intervals ΔL2 of 4 to 6 mm and arranged on the top surface of the touchpad.

Also, an elastic body 504, such as a polyurethane foam sponge, having a thickness of 1 mm or so is disposed between the negative power lines 503 and the positive power lines 502. The second group of lines 505, which are conductive with a thickness of 0.05 mm or less, are arranged on the elastic body 504 in a direction perpendicular to the first group of lines which are the negative and positive power lines and 502 and 503 connected to the electrodes. The top surface 506 formed of an insulating film is disposed on the second group of lines 505.

The second lines 505 which have no connection with external electrodes makes the negative power lines 503 and the positive power lines 502 connected to the electrodes be shorted when the touchpad is pressed.

The second group of lines 505 may be arranged at intervals of 1 mm smaller than that (4 mm) of the first group of lines. However, when the second group of lines 505 are too densely arranged, a change in electrostatic capacity between the touchpad and a finger is spread over all the touchpad instead of being localized on the contact area and, therefore, disables the pointing function of the touchpad.

The elastic body 504 interposed between the negative and positive power lines 502 and 503 separates the first group of lines 502 and 503 and the second group of lines 505, under no pressing and, makes them contact when the switch unit 120 is pressed as shown in FIG. 5C such that current flows between the first group of lines through second group of lines.

Accordingly, even when the switch unit 120 is installed on the top surface of the sensor unit 110, the pointing function of the sensor unit 110 is not hindered and a signal of a function button is transmitted to the input control unit of a computer when the sensor unit 110 is pressed. Hence the switch can work as the function button.

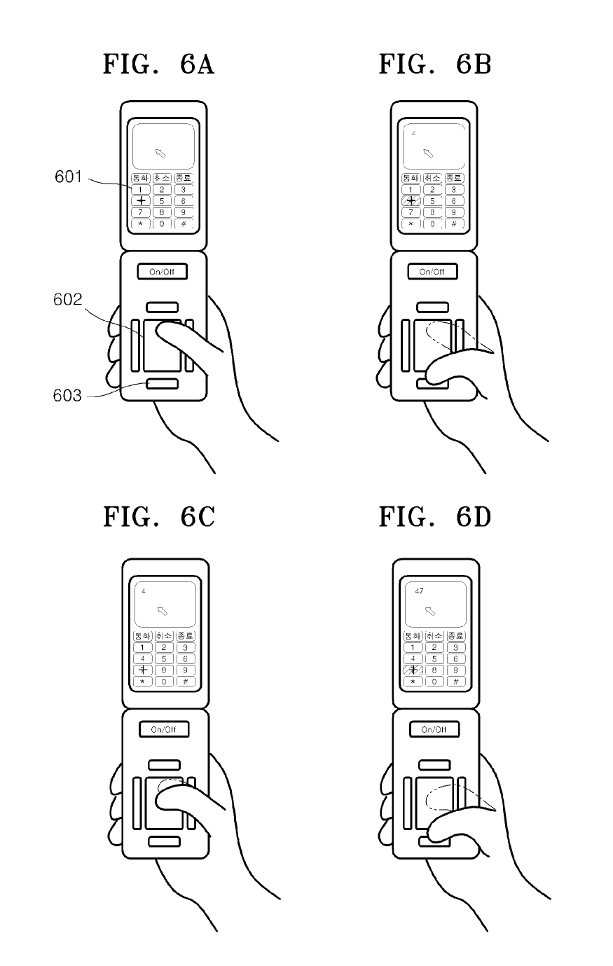

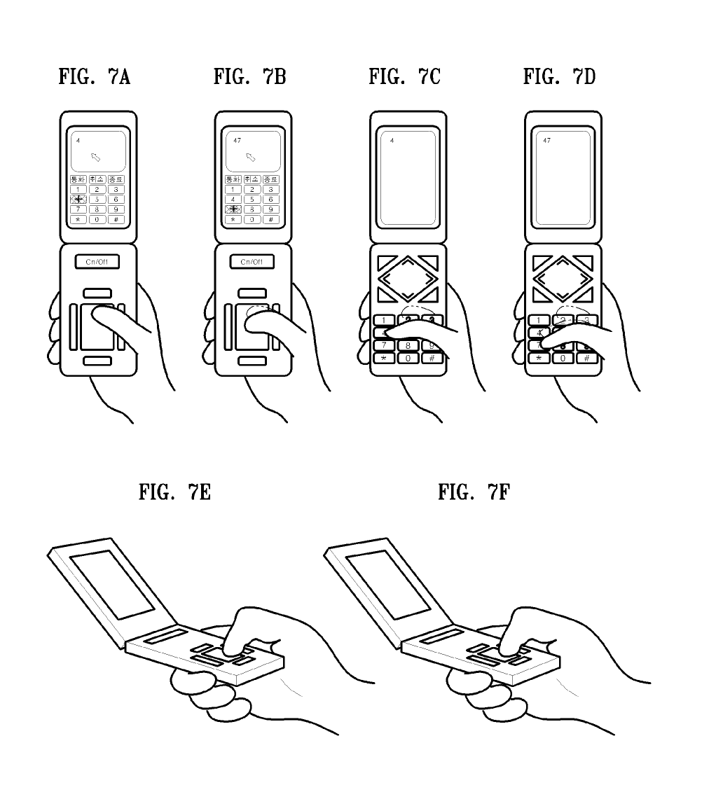

FIG. 6 illustrates a case in which a touchpad and an input switch are separated from each other and operated separately. FIG. 7 illustrates a case of a touchpad having an input switch associated with it in such a way that the input switch is pressed when the touchpad is pressed as shown in FIGS. 2 through 5.

In FIG. 6, the input switch separated from the touchpad may be a mechanical switch, a switch utilizing a change in electrostatic capacity like a general touchpad, or a switch utilizing a change in resistance like a general touchscreen.

FIG. 6 illustrates a one-hand operating procedure of a mobile phone having a pointing device as an input device to input ‘47’.

Referring to FIG. 6A, a pointer is moved to ‘4’ on a virtual keyboard 601 of a screen. Referring to FIG. 6B, a command button 603 is pressed with a user's thumb to input ‘4’ into the screen. Referring to FIG. 6C, the thumb is moved downward on the touchpad 602 to move the pointer to ‘7’ on the screen. Referring to FIG. 6D, the thumb is moved from the touchpad 602 to the command button 603, and the command button 603 is pressed to input ‘7’ into the screen.

FIGS. 7A-7F illustrate that the operating procedure for a cellular phone having a touchpad which works as a function button as shown in FIGS. 2 through 5 is the same as for conventional keypad mobile phone of FIGS. 7C and 7D.

That is, since the touchpad of the cellular phone also serves as the function button, when ‘47’ needs to be input, the operations of FIGS. 6B and 6D are not necessary and just the operations of FIGS. 6A and 6C are performed. Accordingly, referring to FIG. 7A, a finger is moved around on the touchpad to select ‘4’ on the screen and then the touchpad is pressed to input ‘4’, like in the conventional cellular phone of FIG. 7C. Next, the finger is moved around on the touchpad to select ‘7’ and then the touchpad is pressed to input ‘7’, like in the case of the conventional cellular phone of FIG. 7D.

FIGS. 7E and 7F illustrate a touchpad in a touched state and in pressed state, respectively to perform a pointing function and switch function. Even a conventional touchpad works as a function button when the touchpad is tapped once or twice with a finger. In this case, as soon as the finger is separated from the touchpad, a pointer may be moved, thereby causing an error not to execute the desired command. Furthermore, due to such additional vertical motions of the finger for tapping, more energy and longer time is spent in the conventional touchpad to input a character than in a conventional keypad cellular phone, thereby lowering input efficiency.

The sensor unit 110 may be installed as two separate units, the first sensor unit and the second sensor unit.

When the two sensor units are used, letters can be more rapidly input by using both hands. That is, when one sensor unit is used, there is little difference in speed even though letters are input with both hands. However, in the case of two sensor units, letters are input more rapidly with both hands, as follows; while any one of virtual keys assigned to the first sensor unit is input with one hand, the other hand is placed on a next virtual key to be input among virtual keys assigned to the second sensor unit and when it comes to the next virtual key turn, the switch unit 120 is just turned on, thereby increasing a typing speed as compared to the case of one sensor.

At this time, each of the first and second sensor units may be provided with a separate switch unit 120, or only one switch unit 120 may be shared by all the sensor units. When the switch unit 120 is turned on by pressing the sensor unit 110, the switch unit 120 is necessary to each of the sensor units separately. Otherwise, only one switch unit 120 may be used.

Also, the two sensor units may be realized by using two separate touchpads, or by separating the virtual keyboard into two sections and assigning each section to a different region of one touchpad.

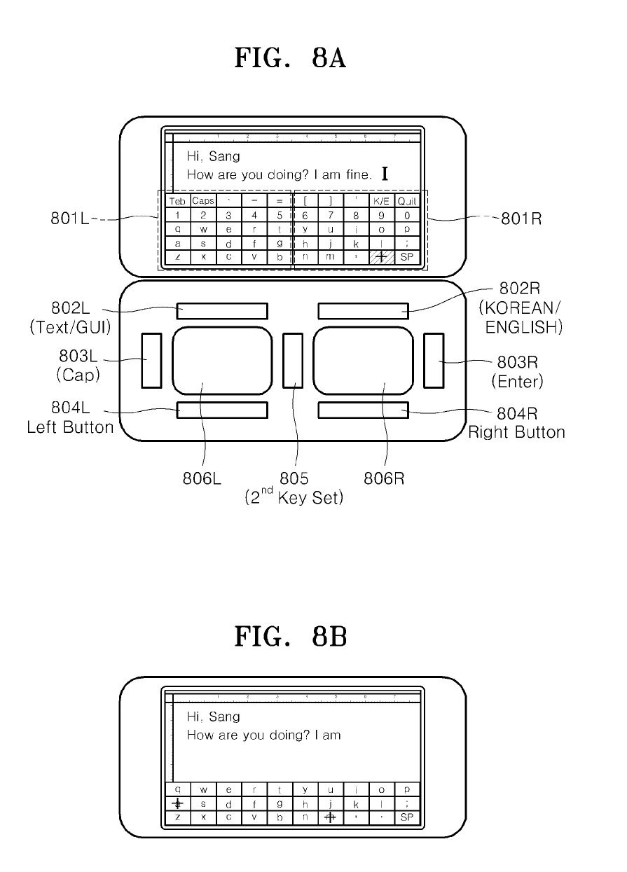

FIGS. 8A-8B illustrate a virtual keyboard input system of two sensor units (touchpads) according to an embodiment of the present invention.

A cellular phone using two touchpads can be a folding- or a sliding-type cellular phone, and inputting letters is done with both hands and making calls with only one hand. Accordingly, both the voice communication function of the cellular phone and the text input function as a digital device can be easily performed.

In FIG. 8A, the two touchpads are associated with two cursors in a text input mode, and the cursors cannot pass over a central border line and are respectively moved in the left region and the right region. Each of the two touchpads has four function buttons 802 through 805. The four function buttons perform different functions when the cellular phone is used and are arranged to be operated easily with one hand or two hands. A conventional keyboard with four rows may be used for text input convenience as shown in FIG. 8A, or a shortened keyboard having three rows may be used as shown in FIG. 8B.

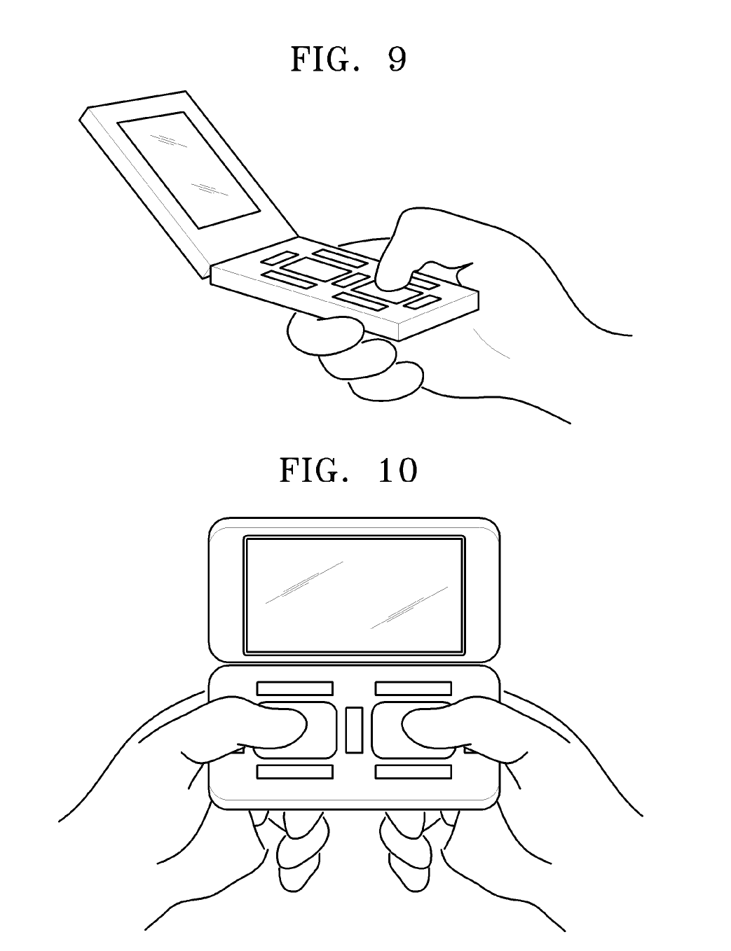

FIGS. 9 through 11A-11C illustrate the virtual keyboard input system of FIGS. 8A-8B used in different modes.

FIG. 9 illustrates a bar-type cellular phone in a vertical mode according to an embodiment of the present invention which can be used with one hand to conveniently dial numbers and receive or make calls.

FIG. 10 illustrates a cellular phone in a horizontal mode according to an embodiment of the present invention which can be used with both hands to input letters and adopt a GUI system without difficulty.

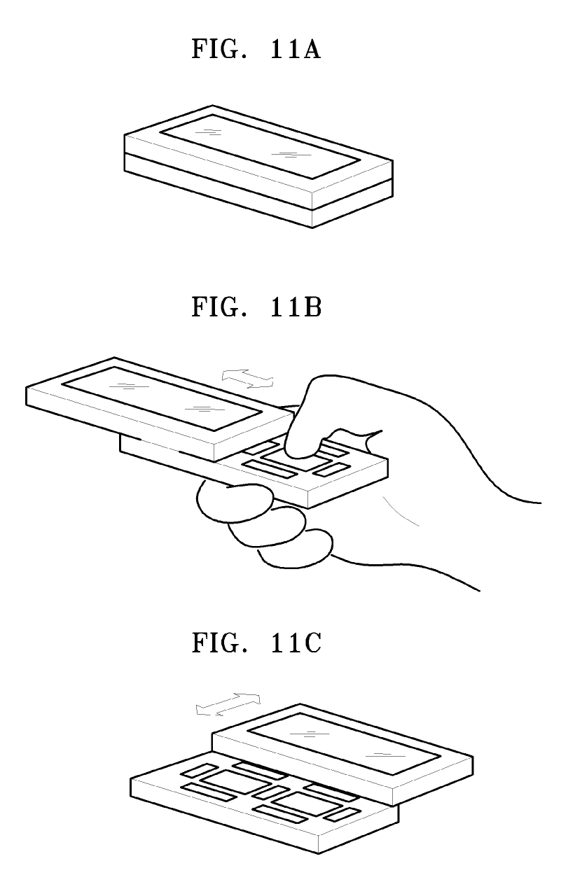

FIG. 11A illustrates a double sliding-type cellular phone having two touchpads which can be used in both horizontal and vertical modes respectively as shown in FIG. 11C and FIG. 11B.

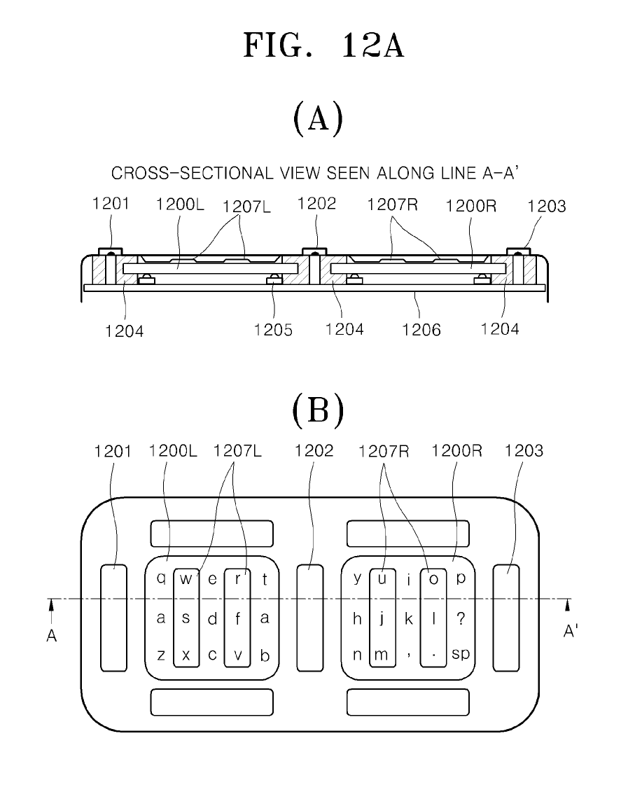

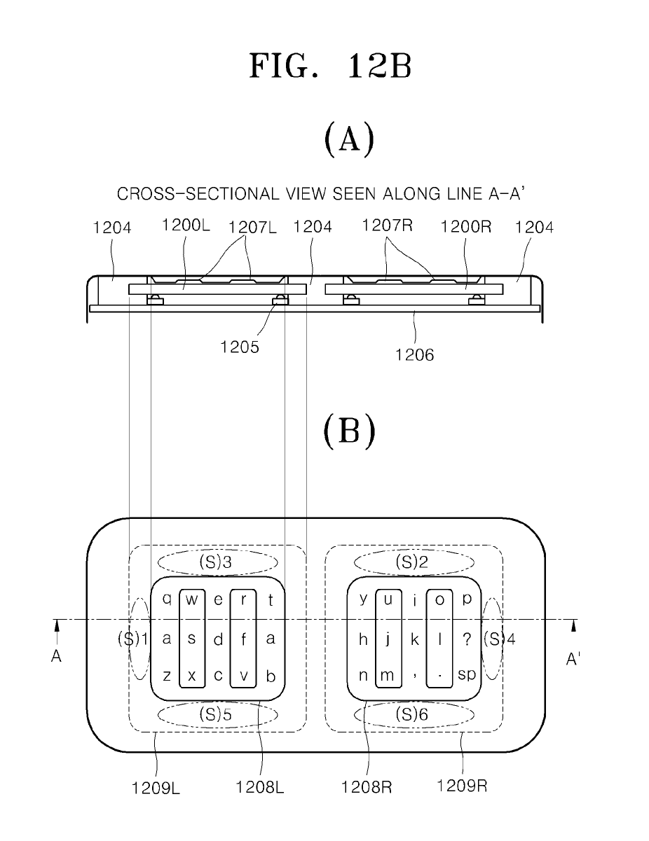

FIG. 12A is a cross-sectional view of touchpads 1200L and 1200R and illustrates the arrangement of function buttons accompanying the touchpads 1200L and 1200R. Referring to FIG. 12A, dome switches 1201, 1202, and 1203 act as function buttons and dome switches 1205 are also disposed under the touchpad 1200L and 1200R. Referring to FIG. 12B, edge portions (S)1, (S)2, (S)3, (S)4, (S)5, and (S)6 of the touchpads 1200L and 1200R instead of mechanical buttons perform switch functions by using a change in the electrostatic capacity of the touchpads 1200L and 1200R when the edge portions (S)1, (S)2, (S)3, (S)4, (S)5, and (S)6 are tapped.

Since the edge portions (S)1, (S)2, (S)3, (S)4, (S)5, and (S)6 are covered by a case body, tapping does not cause a movement of the dome switches 1205 and hence no operation since they operate with a vertical movement of touchpad regions 1208L and 1208R.

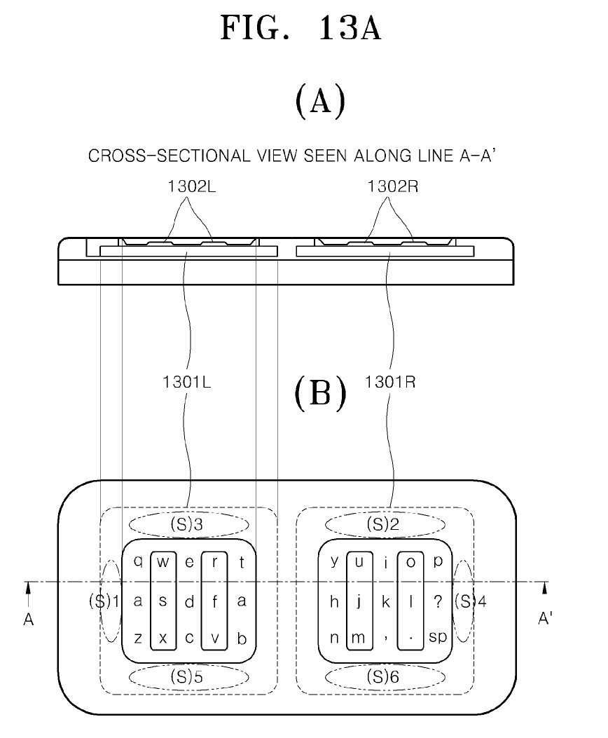

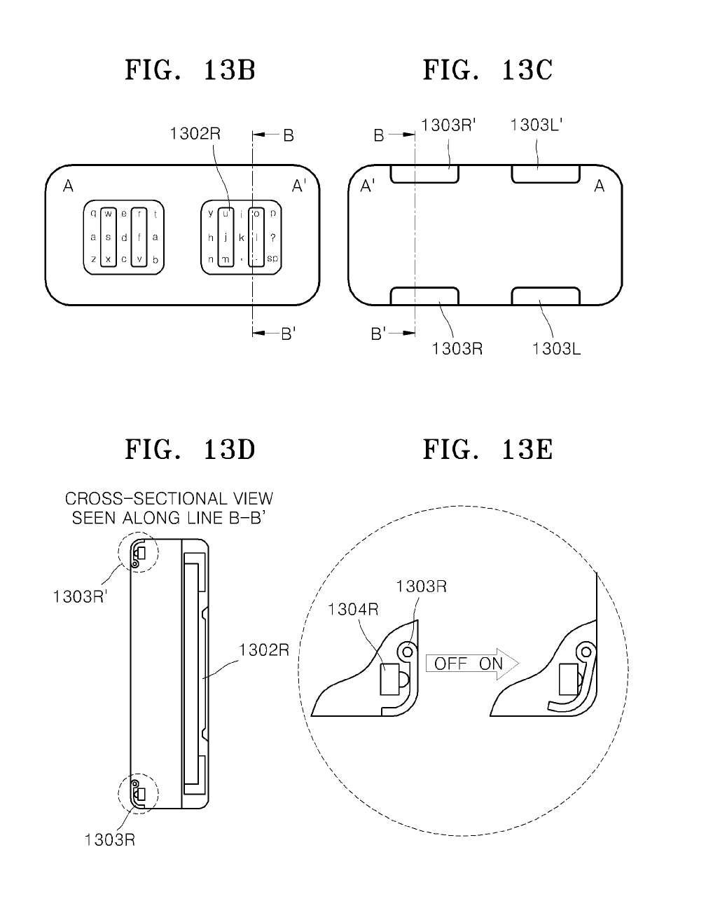

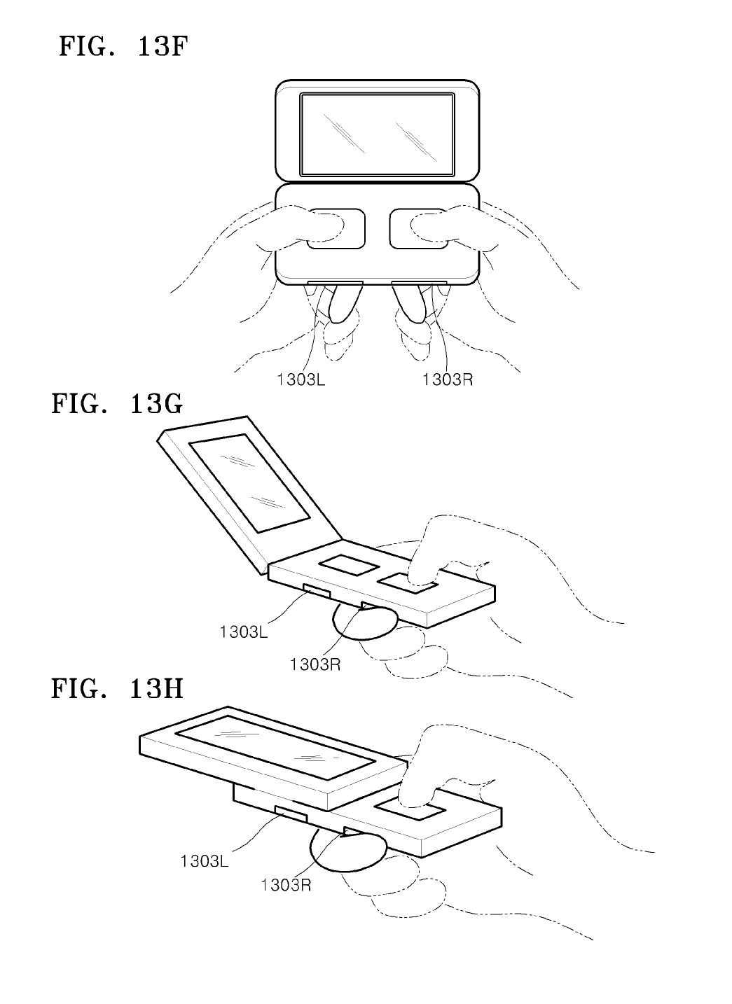

FIG. 13A illustrates a case in which dome switches are not disposed under touchpads 1301L and 1301R. FIG. 13B illustrates a plane view of a top surface and FIG. 13C illustrates a plane view of a bottom surface. FIG. 13D illustrates a cross-sectional view along line B-B'. FIG. 13E is for showing function of switches 1303R. Referring to FIG. 13B, switches are disposed on a rear surface of a cellular phone, that is, a surface opposite to a frontal surface where the touchpads 1301K and 1301R are placed. In detail, switches 1303L, 1030L′, 1303R, and 1303R′ are disposed on edges of upper and lower ends of the rear surface of the cellular phone.

When switches are disposed on edges of a rear surface of a cellular phone, a user can more easily press the switches while holding the cellular phone in one hand than in the case where switches are disposed on other parts than the edges of the rear surface of the cellular phone.

The switches may include ‘L’-shaped levers and dome switches 1304L and 1304R and may be disposed on edges or other parts of the rear surface. FIG. 13C illustrates the switches pressed and operated with a hand or two hands.

The switches 1303L′ and 1303R′ disposed on the upper end of the rear surface of the cellular phone may be omitted, or only the switches 1303L and 1303R except the switches 1303L′ and 1303R′ may be programmed to be operated by a software.

FIG. 13F illustrates the position of a finger for the right-handed in a horizontal (landscape) mode (text input mode). FIG. 13G and FIG. 13H illustrates the position of a finger for the right-handed in a vertical (portrait) mode (phone mode).

Since thumbs can be freely moved and the switches 1303L and 1303R can be easily operated in FIG. 13F-13H, the same easiness as that obtained when switches are disposed under touchpads can be obtained.

The virtual keyboard input system according to the present invention can perform both a text input function and a pointing function.

When a user uses a digital device including the virtual keyboard input system according to the present invention, he/she may select a pointing mode or a text input mode by using a separate switch or a menu icon on the screen and perform a corresponding function.

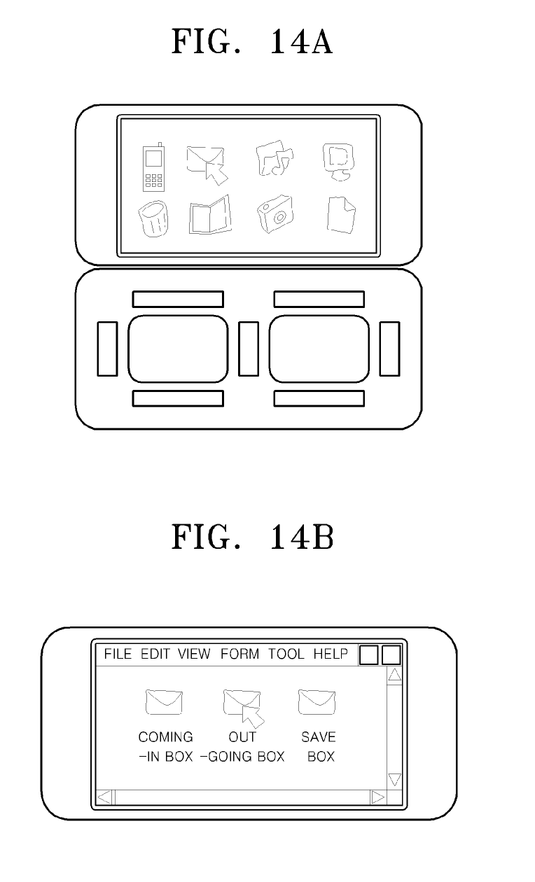

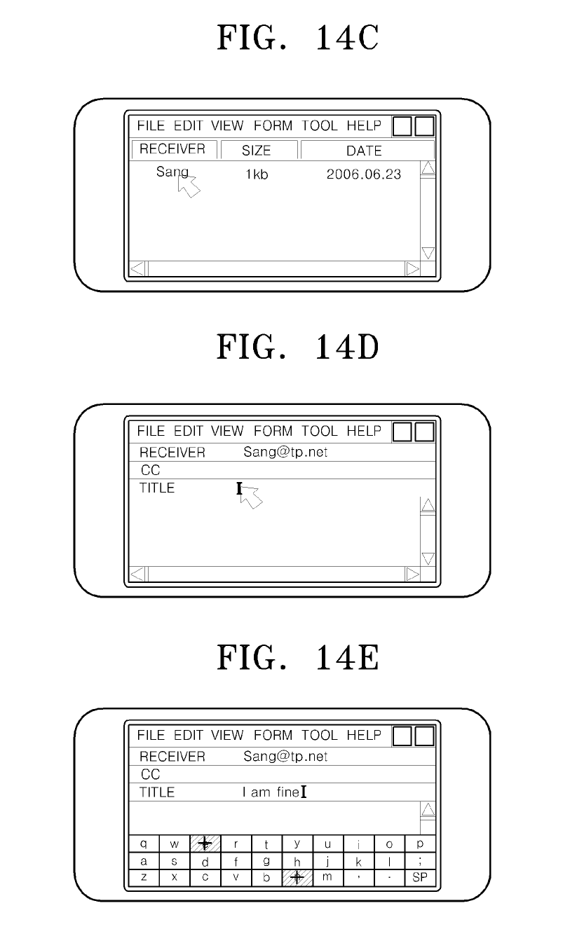

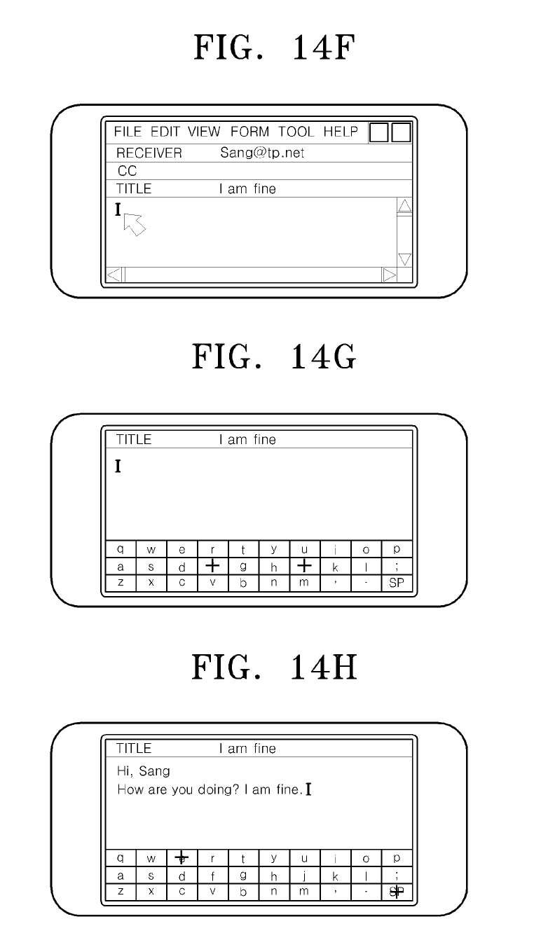

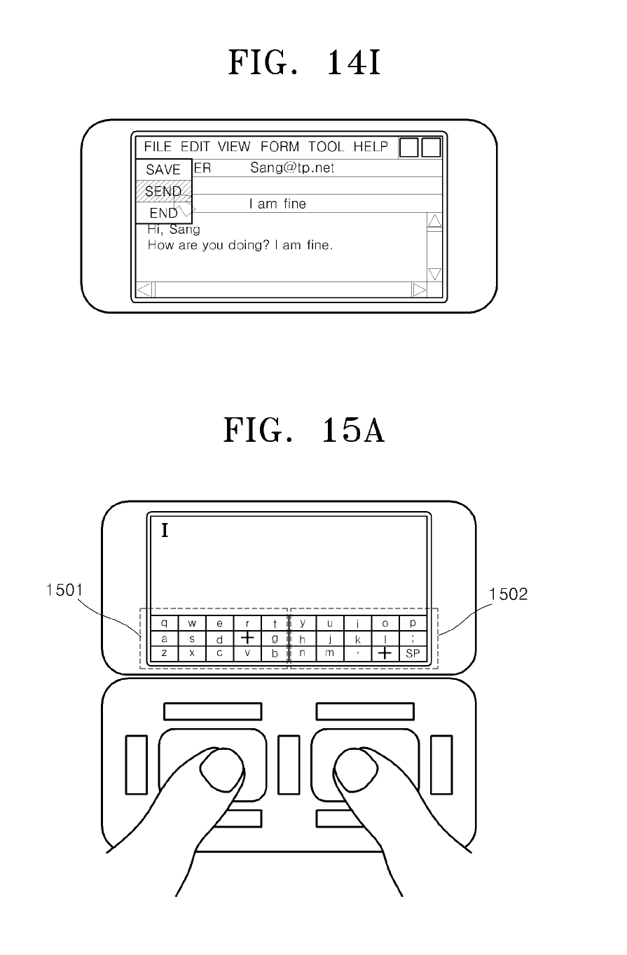

FIGS. 14A-14I illustrate an operating procedure for a cellular phone employing a virtual keyboard input system in a horizontal mode to use an E-mail program, like in a GUI system of a conventional computer when two sensor units 110 are touchpads. Referring to FIG. 14A, the cellular phone is turned on to show a main screen. Referring to FIG. 14B, a pointer is moved to an E-mail menu icon and a touchpad is quickly double clicked to open the E-mail program. Referring to FIG. 14C, the pointer is moved to an outbox menu icon and select button 804L is double clicked to open the list of sent e-mails.

Referring to FIG. 14D, one item of the list is clicked to open the selected mail such that editing can be made to the mail. The pointer is moved to a position where letters to be input and select button 804L is double clicked to display a text cursor.

Referring to FIG. 14E, text/GUI mode converting button 801L is pressed to open a virtual keyboard at a lower portion of a screen such that the position where letters are to be input is placed right over the virtual keyboard.

Referring to FIG. 14F, after title is input, the pointer is moved to a text body and the select button 804L is double clicked to display a text cursor.

Referring to FIG. 14G, text/GUI mode converting button 801L is pressed to show the virtual keyboard. Referring to FIG. 14H, the pointer is moved to a ‘quit’ button and the touchpad is clicked to end a text input mode. Referring to FIG. 14I, text/GUI mode converting button 801L is clicked to change to a UI mode. For example, the pointer may be moved to ‘file’ and select button 804L may be pressed to open and execute a menu, such as ‘store’, ‘send’, or ‘end’. The ‘end’ menu may be selected and select button 804L may be clicked to return to the main screen.

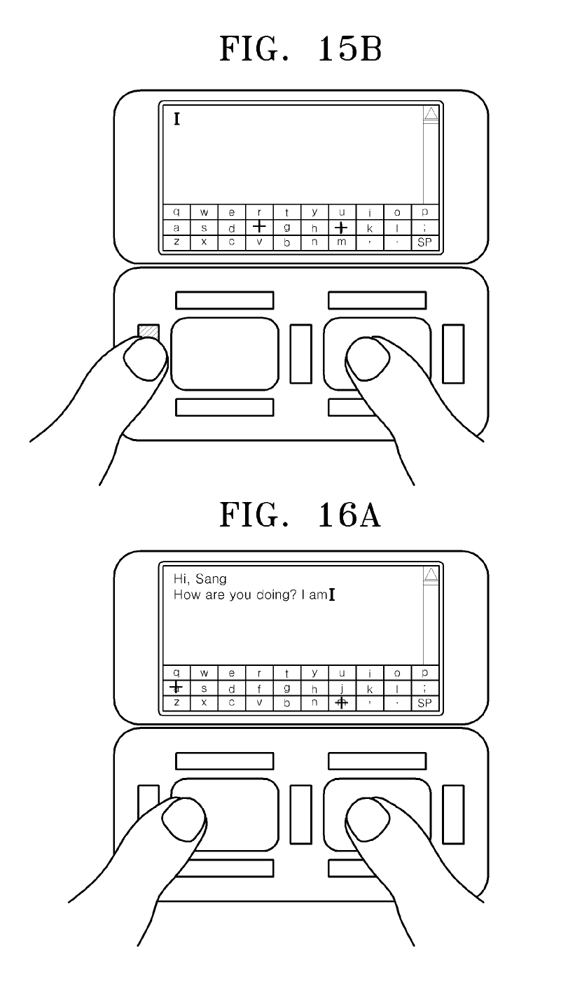

FIG. 15A illustrates a virtual keyboard. FIG. 15A illustrates the virtual keyboard displayed on a screen in a text input mode where left and right pointers (cursors) are located on ‘f’ and ‘j’, respectively. The two left and right pointers on the virtual keyboard cannot cross over the central border and are respectively moved in a left region 1501 and a right region 1502.

Like in a computer keyboard, the left pointer is moved with the left thumb and the right pointer is moved with the right thumb to improve text input efficiency. Since the two pointers do not interfere with each other and are always moved in their own regions no matter how the touchpads are operated, both the thumbs can be freely moved and the same text input efficiency as that of a QWERTY keyboard can be achieved.

Since the functions of ‘enter’, ‘Korean/English convert’, and ‘caps (small/capital letter convert)’ buttons, which are often used to input letters as shown in FIG. 14G, are performed by function buttons around the touchpads at fixed positions, the function buttons can be operated easily and text input efficiency can be improved. When the ‘caps’ function button is pressed, a key of the virtual keyboard is changed to a capital letter mode (see FIG. 15B).

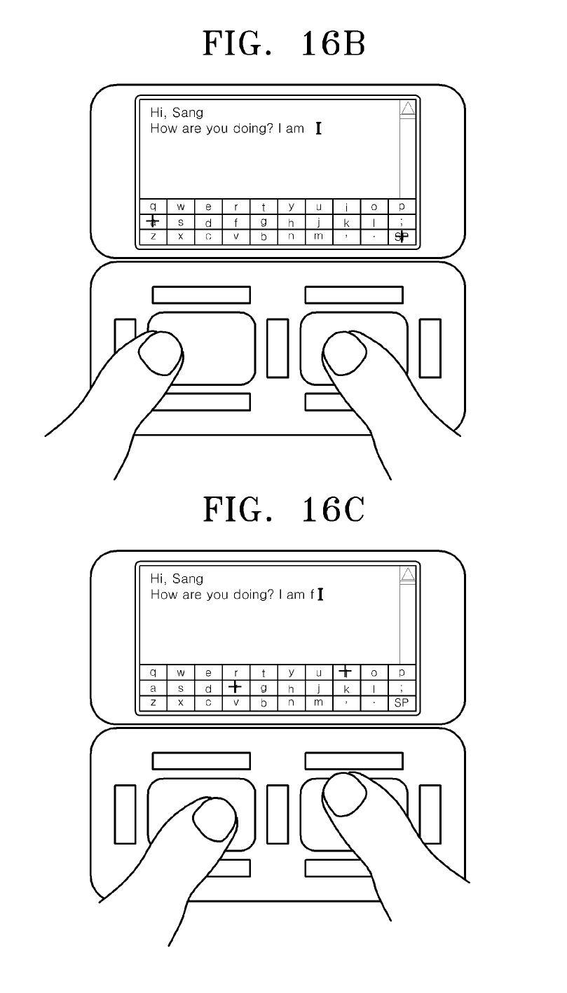

FIG. 16A illustrates a method of inputting the text “ . . . I am fine.”

Referring to FIG. 16A, ‘ . . . am’ is already input. Referring to FIG. 16B, a space function button is pressed to input a space. Referring to FIG. 16B, the right thumb is moved to a right lower end of the touchpad and a space function button is pressed to input a space. Referring to FIG. 16C, cursors are located on ‘f’ and ‘i’ to input ‘fine’, and the left and right touchpads are sequentially pressed.

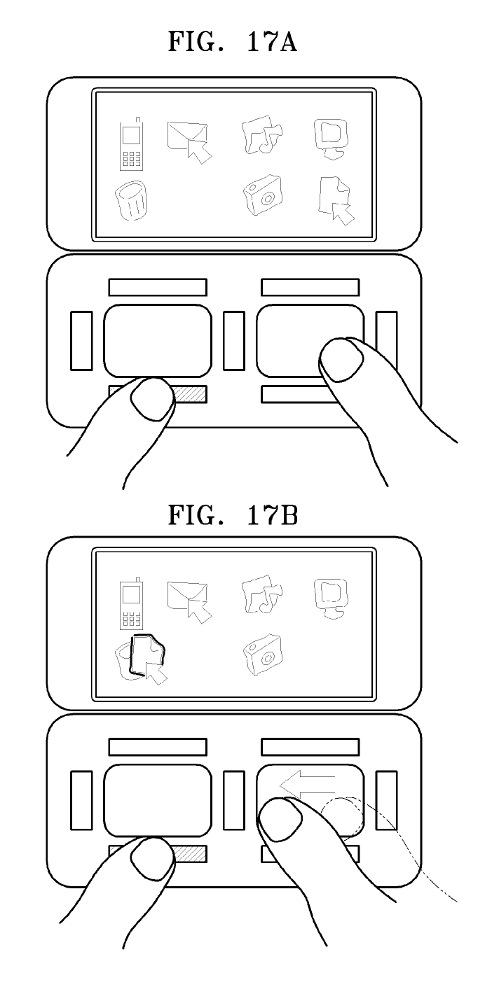

FIGS. 17A-17B illustrate a cellular phone having two touchpads and multiple function buttons. The cellular phone can easily operate a GUI system like having a mouse.

Referring to FIG. 17A, a document is selected by using a right touchpad and a command button disposed under a left touchpad. Referring to FIG. 17B, the document is moved to a wastebasket by using the right touchpad while the command button is being pressed. When it is a system of one pointer and two pointing devices, the two pointing devices are independently operated and thus can be conveniently used for both the left- and right-handed people like having a mouse.

As shown in FIG. 17A, a right-handed person may use the right touchpad and a left-handed person may use the left touchpad. When the select buttons 804L and 804R are switchable like in a mouse, the operation procedure for the right-handed person in FIG. 17B may be applied to the left-handed person.

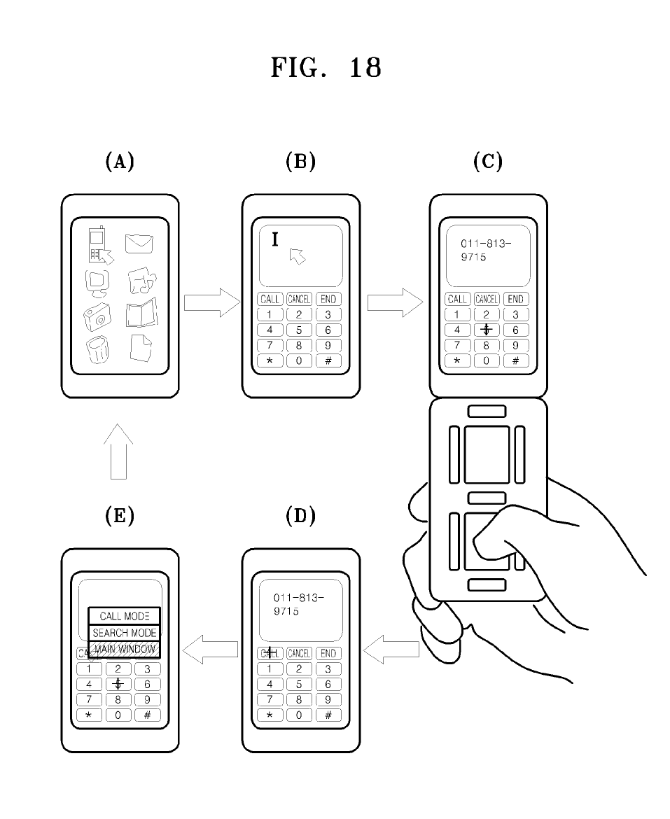

FIG. 18 illustrates a procedure of operating a cellular phone in a vertical mode using a GUI system to make calls, wherein making calls using the GUI system is the same as that using a conventional cellular phone.

Referring to FIG. 18, the cellular phone is turned on to show the initial screen. Referring to FIG. 18, a pointer (cursor) is moved to a phone-mode icon and a touchpad is double clicked to open a virtual keypad. Referring to FIG. 13F-13H, the cursor is sequentially moved to desired numbers and the touchpad is sequentially pressed to input 011-813-9715 into a screen. Referring to FIG. 18, the cursor is moved to a ‘call’ key of the virtual keyboard and the touchpads is pressed to make a call. An ‘end’ key is pressed to end the call.

Differently from a conventional cellular phone, even when a wrong number is input, all previously input numbers do not need to be erased. Only the very wrong number is selected, a ‘cancel’ key is pressed to erase the wrong number, and then a new number is input. The cellular phone of FIG. 18 inputs and corrects letters in the same manner as that using a computer mouse. The cellular phone according to the present invention can also be programmed to perform the function of a conventional cellular phone.

Accordingly, if an existing calling method using a keypad is familiar, the cellular phone can be programmed to use the existing calling method. For example, when only last 9715 are input, 011-813-9715 corresponding to the numbers 9715 may be shown on the screen and a call may be made to 011-813-9715 by pressing the ‘call’ key. Also, when ‘1’ is pressed for a long time, that is, when the touchpad is pressed for a long time, a call may be made to a previously input telephone number corresponding to “1”. Referring to FIG. 18, in order to return to the GUI system that is the initial main screen, a hidden menu is summoned, a cursor is moved to ‘main screen’ item in the menu, and the touchpad is pressed.

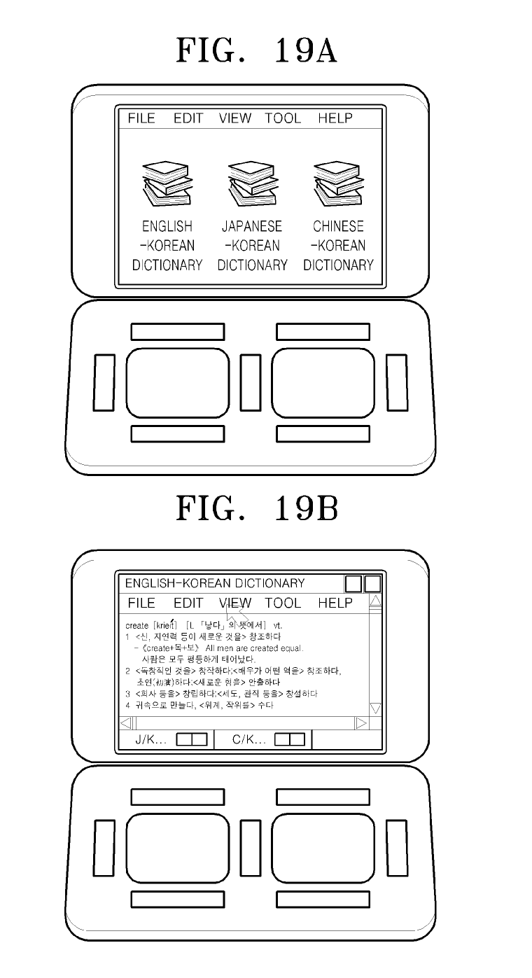

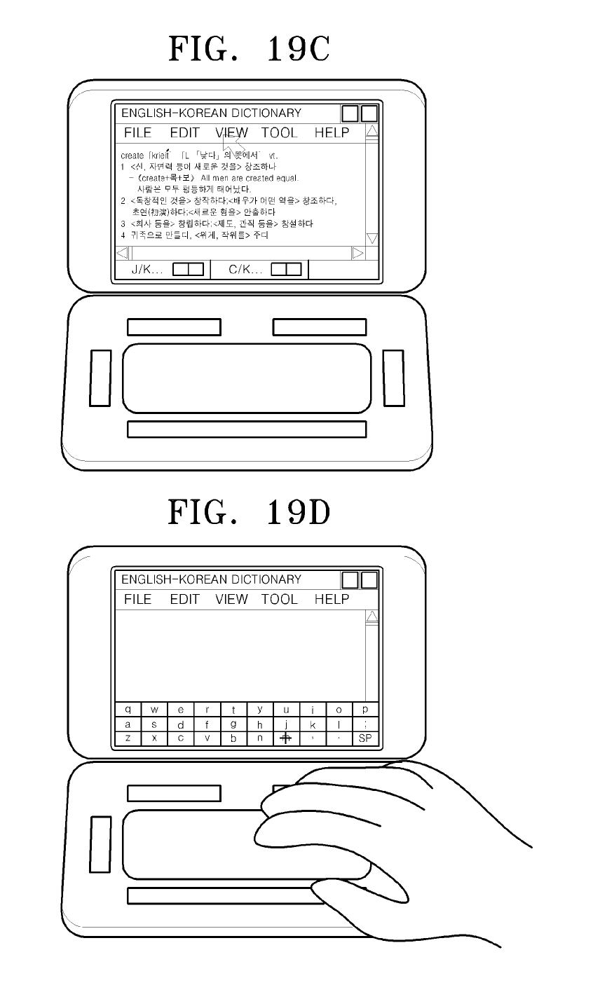

FIGS. 19A-16D illustrate an electronic dictionary employing a virtual keyboard input system according to an embodiment of the present invention. FIGS. 19A and 19B illustrate an electronic dictionary having two touchpads. FIGS. 19C and 19D illustrate an electronic dictionary having one touchpad.

Since the electronic dictionary having the touchpad(s) is operated based on a GUI system, internal dictionaries can be used in the same manner as computer application programs.

FIGS. 19C and 19D illustrate the electronic dictionary having only one touchpad. In general, an electronic dictionary is often laid down on the bottom and used with one hand. In this case, if a virtual keyboard is used as a UI system using a single touchpad, the electronic dictionary can more conveniently use the virtual keyboard like a mouse than a conventional electronic dictionary having a keyboard.

Uneven members, such as projections or grooves, may be formed on a surface of the sensor unit 110 so that a user can easily distinguish division regions.

In the case of a touchpad that does not have to be transparent like a touchscreen, a virtual keyboard may be printed on the touchpad and a user may input letters while directly seeing the printed keyboard. However, the printed virtual keyboard may be covered by the user's hand sometimes, and when the user concentrates his/her attention to a screen, he/she has no chance to see the touchpad. Accordingly, it is preferable that positions of desired virtual keys be perceived by fingers.

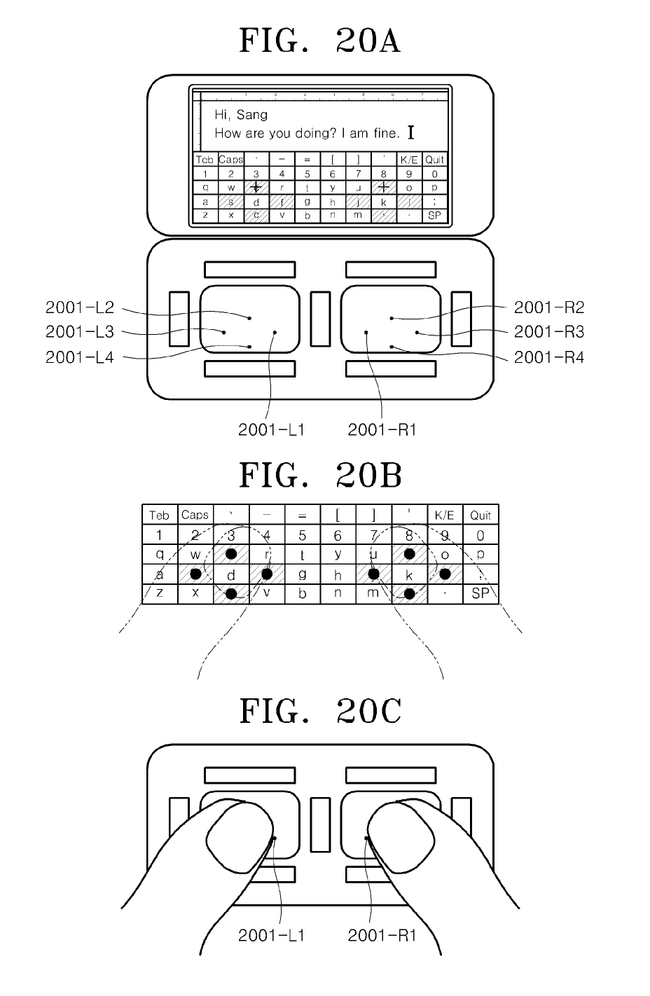

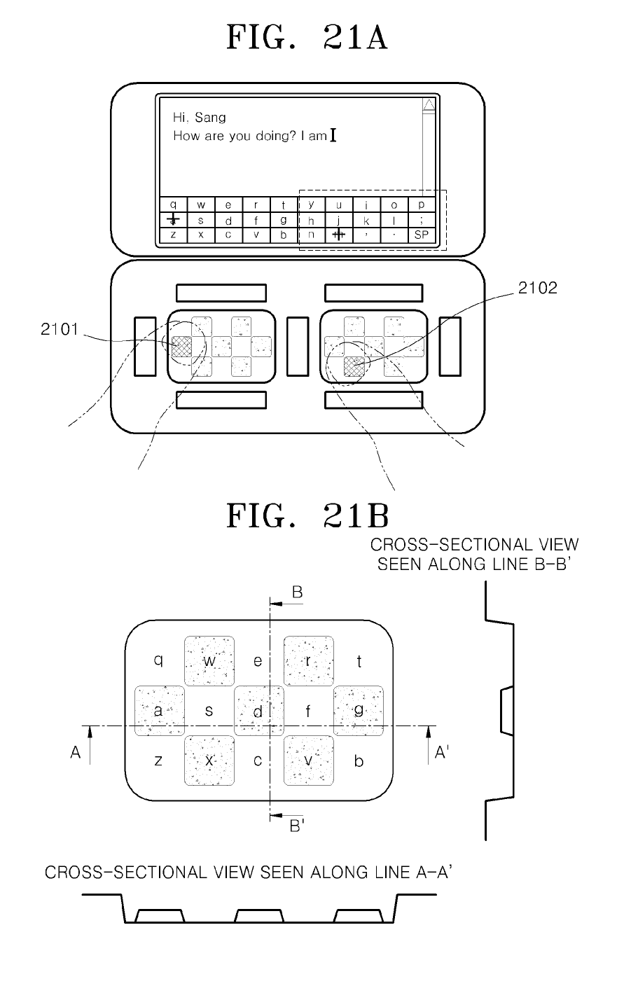

Such uneven members may have point shapes as shown in FIG. 20, or grid shapes as shown in FIGS. 12 and 21. The uneven members used as reference points enable the user to easily know the positions of fingers on a touchpad such that he/she can move the fingers to desired letters or numbers to be input without seeing the screen.

FIGS. 20A-20C illustrate a cellular phone having two touchpads on which two or more reference points are formed associated with two or more keys of a virtual keyboard to more easily input letters using the virtual keyboard.

Referring to FIG. 20A, when four reference points 2001-L1, 2001-L2, 2001-L3, 2001-L4, 2001-R1, 2001-R2, 2001-R3, and 2001-R4 formed on left and right touchpads are respectively associated with s, e, f, c and j, l, l, and m of the virtual keyboard, letters to be input can be known without seeing a screen from relative positions from the reference points perceived by fingers.

For example, when the virtual keyboard is started, pointers are automatically located on ‘f’ and ‘j’ of the virtual keyboard. Referring to FIG. 20B, when fingers are located on the reference points 2001-L1 and 2001-R1 and the pointers begin to be moved, the finger on the left touchpad is moved from the reference point 2001-L1 to the reference point 2001-L3, and accordingly, the pointer is moved from ‘f’ to ‘s’ on the screen. In this condition, as the touchpad is pressed, ‘s’ is input.

That is, since relative positions from the reference points are perceived by fingers, how far and in which direction the fingers are to be moved can be known without seeing the screen like using a real keyboard.

Accordingly, since the position of each key of the virtual keyboard is set with reference to the reference points, the virtual keyboard has the same convenience as that of the real keyboard, although there is a difference in that while the real keyboard is used with all five fingers, the virtual keyboard is used with only one finger.

FIGS. 20B and 20C illustrate the positions of fingers corresponding to the reference points on the touchpads and the positions of keys corresponding to the reference points on the virtual keyboard, respectively.

FIGS. 21A-21B illustrate a digital device having two touchpads on which crossword-puzzle-patterned projections are formed as reference points to easily perceive relative positions of keys in a virtual keyboard.

Since the crossword-puzzle-patterned projections guide fingers to linear movements and help identify the positions of keys, the relative positions of the fingers for the virtual keyboard can be easily recognized.

Dark square regions 2101 and 2102 correspond to ‘a’ and ‘m’ of the virtual keyboard, respectively. Such square projections are shown in FIG. 21B. The touchpads are lower than surroundings by 5 mm or less, edge portions of the touchpads guide fingers, and the projections 2101 and 2102 protrude by 1 mm or less from the surroundings and enable positions to be recognized without blocking the movements of the fingers.

However, in order not to affect a change in the electrostatic capacity of the touchpads, the projections 2101 and 2102 may have a thickness of less than 0.5 mm, and preferably less than 0.1 mm. Since it is not desirable that a cellular phone gets thicker because of a touchpad, a difference in height between the touchpads and the surroundings should be reduced as much as possible, and even when the difference is less than 1 mm, the projections 2101 and 2102 can guide fingers.

Referring to FIG. 12, since uneven members 1207L and 1207R reveals cross section of different heights in the x direction but flat in the y direction, positions in the x direction can be easily grasped and positions in the y direction can be easily grasped by using edge regions of the touchpad 1208L and 1208R. Only boundaries of the division regions may protrude in order to distinguish division regions. The shapes or types of the uneven members used to distinguish the division regions are not limited to the illustrations.

Also, besides the uneven members on the touchpads, corners of the touchpads contacting the surroundings may act as reference points. For example, the touchpads are divided into upper, middle, and lower zones, the upper and lower zones have corners acting as reference points, and thus the positions of the middle zones spaced apart from the corners can be easily known.

The division regions of the touchpads may have uniform areas or different areas.

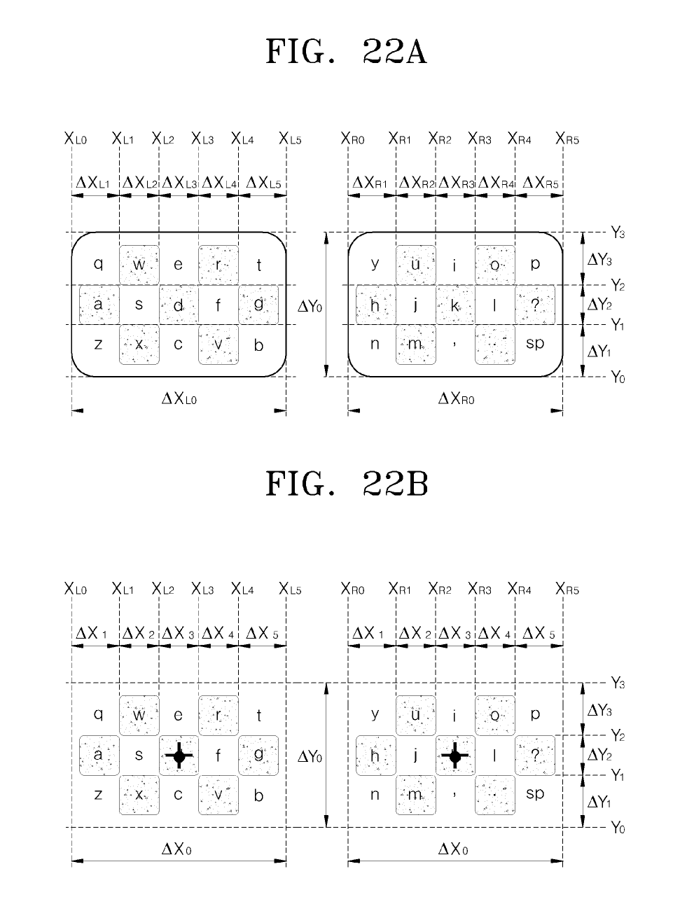

FIGS. 22A-22B are illustrations to explain a method of inputting letters when division regions of two touchpads have uniform areas according to an embodiment of the present invention.

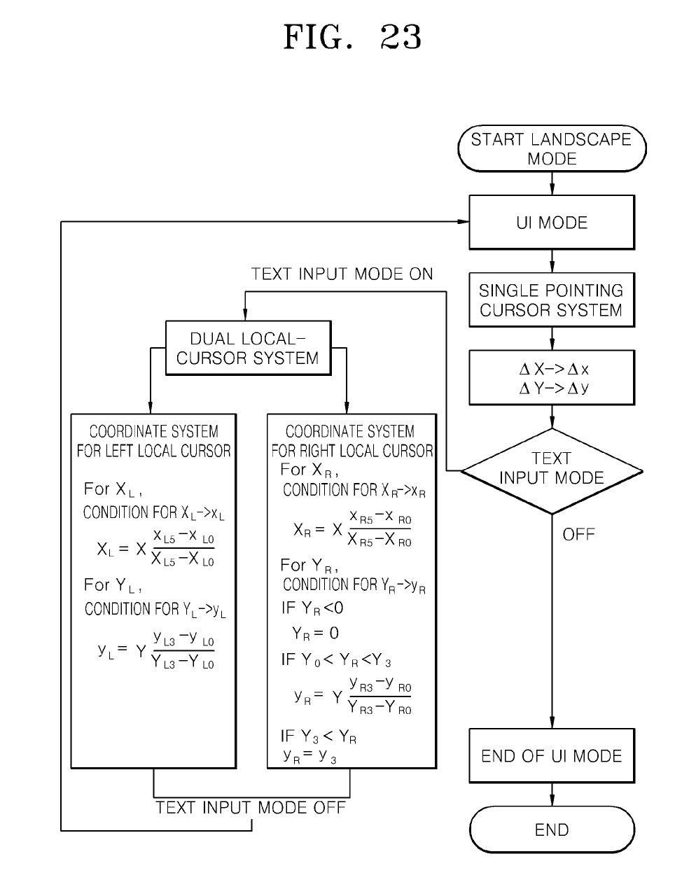

FIGS. 22A and 22B illustrate coordinate systems of touchpads and of a virtual keyboard, respectively which are the basis of the operating principle to be explained with reference to FIG. 23 later.

Since the coordinate systems of the left and right touchpads are independently operated, the coordinate systems are represented by L and R. However, the coordinate systems of the virtual keyboard are not divided, and range from −x₅ to +x₅.

In the coordinate systems of the virtual keyboard of FIG. 22, Δx₁=Δx₂=Δx₃=Δx₄=Δx₅, and Δy₁=Δy₂=Δy₃. Likewise, in the coordinate systems of the touchpads, ΔX₁=ΔX₂=ΔX₃=ΔX₄=ΔX₅ and ΔY₁=ΔY₂=ΔY₃.

As described above, the operating principle of a touchpad according to the present invention is different from the operating principle of a conventional touchpad in a pointing mode. That is, in a conventional user interface (UI) mode, the movement of a cursor is determined by receiving data corresponding to the displacement (Δx, Δy) of the cursor in X and Y directions from a signal (ΔX, ΔY), which corresponds to finger's displacement, generated from a touchpad or a mouse that is a pointer input device, and a new position for the cursor is determined by using a relative coordinate system. However, in a text input mode, according to the present invention, the movement of a cursor is determined on the basis of an absolute coordinate system. That is, a point on a touchpad corresponds to a point on a virtual keyboard. That is, the present invention uses an absolute coordinate system in which coordinates on a touchpad and the position of a pointer on a screen correspond to each other in a one-to-one manner.

In other words, referring to FIG. 22B, when a pointer (crosshair cursor) is located as follows,

x_{L2}<x≦x_{L3}

y₂<y≦y₃,

and a command button (a touchpad switch in FIGS. 2, 4, 12, and 13A, and a separate switch in FIG. 13B-13D) is pressed, ‘d’ is input. For this condition, fingers on the touchpads should be equally located as follows,

X_{L2}<X≦X_{L3}

Y₂<Y≦Y₃.

That is, coordinates (x, y) of cursors are calculated from signals ((X, Y)-coordinates of fingers) generated from the two-dimensional pointing devices like touchpads and the cursors are placed on the corresponding positions on the virtual keyboard. In the text input mode, key positions are determined by coordinates (x, y) of cursors corresponding to coordinates (X, Y) of fingers when the left cursor is given by −x₅≦x≦x₅, y₀≦y≦y₃ and the right cursor is given by −x₅≦x≦x₅, y₀≦y≦y₃, and a method of obtaining (X->x, Y->y) using this method is shown in FIG. 23.

For example, there is little difference between when the right thumb moves to ‘y’ while being touching ‘p’ on the right touchpad and when the right thumb moves to ‘y’ after being separated from ‘p’ on the right touchpad in a text input mode. This is a difference between the operating principle of the conventional touchpad in a pointing mode and the operating principle of the touchpad according to the present invention in the text input mode.

In a general UI mode, not a text input mode, the displacement (Δx, Δy) of a cursor is calculated from the displacement (ΔX, ΔY) of a finger over a touchpad, and the ratio of the displacement (Δx) of the cursor corresponding to the displacement (ΔX) of the finger may be arbitrarily adjusted for user convenience. Such cursor operating principle is shown in FIG. 23. Accordingly, when cursors on a screen are controlled by using two touchpads according to the present invention, both a conventional relative coordinate signal method and an absolute coordinate signal method are used.

The conventional relative coordinate signal method and the absolute coordinate signal method used by the present invention will be explained with reference to FIG. 14.

Referring to FIG. 14A, a cellular phone employing a virtual keyboard input system is operated in a horizontal mode. A main screen and one pointer (cursor) are shown. Since the pointer can be moved over the whole screen, the pointer is referred to as a whole area cursor. The whole area cursor is controlled by matching the displacement (ΔX, ΔY) of a finger to the displacement (Δx, Δy) of the pointer in the same manner as a pointing method of a conventional touchpad. A constant Q is a proportional constant which determines the ratio between finger displacement and cursor displacement as Δx=QΔX and may be adjusted according to user convenience.

While a ‘whole area 1 cursor system’ is operated as FIG. 14A and the operating mode is changed to a text input mode as shown in FIG. 14G, the virtual keyboard input system turns into a ‘defined area 2 cursor system’ in which two pointers are disposed in left and right regions of a virtual keyboard and cannot pass over the central border line.

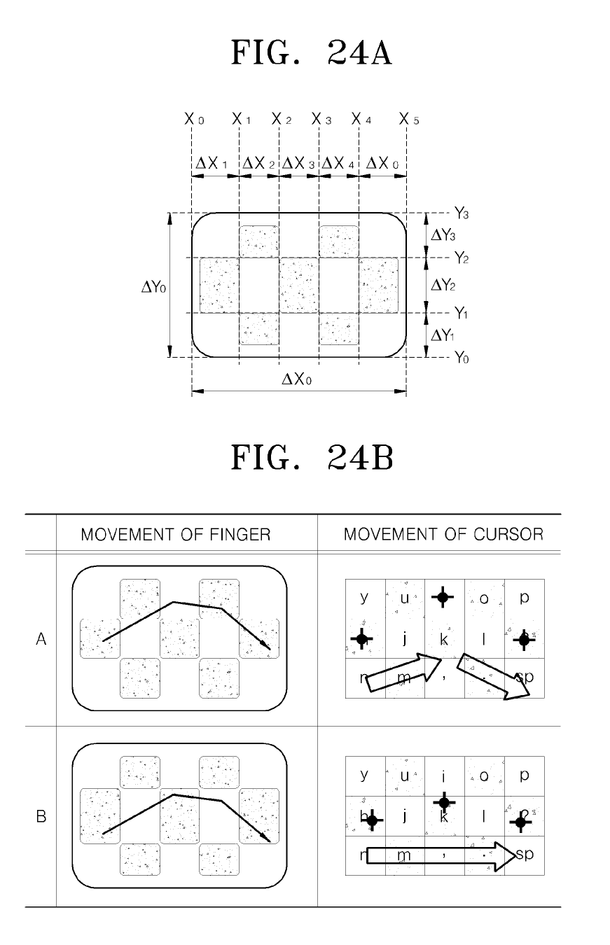

FIGS. 24A and 24B are views for explaining a method of inputting letters when division regions of a touchpad have different areas according to an embodiment of the present invention.

That is, coordinate systems of the touchpads and coordinate systems of cursors nonlinearly correspond to each other.

Fingers operating the touchpads moves in a circular way due to their joints, and are actually difficult to move in a straight direction. When a finger move laterally from the left to the right or in the reverse way on a touchpad, a vertical sway of a finger is unavoidable due to this reason.

In general, in a horizontal mode, since a finger is moved in a large arc over a central horizontal line, it is preferable that division regions in the middle row of a touchpad be larger than in other rows. In a vertical mode, since a finger is moved in a large arc over a central vertical line, it is preferable that division regions in the middle column of touchpad be larger than in other columns.

In detail, referring to FIG. 24B-(A), when a finger moves in a central row corresponding to ΔY₂ of a touchpad, it sways vertically more than when it moves in regions ΔY₁ and ΔY₃ in which the movement of a finger is guided by edges as reference line. Hence there is more chance that the region ΔY₁ or ΔY₃ (corresponding to ‘i’) may be selected.

To solve the problem, referring to FIG. 24B-(B), the region ΔY₂ is increased so that despite the same finger movement as in FIG. 24B-(A), the region corresponding to Δy₂ on a virtual keyboard is selected and “a, s, d, f, g, h, k, [symbol] , ?” in the region of Δy₂ can be more stably selected and input.

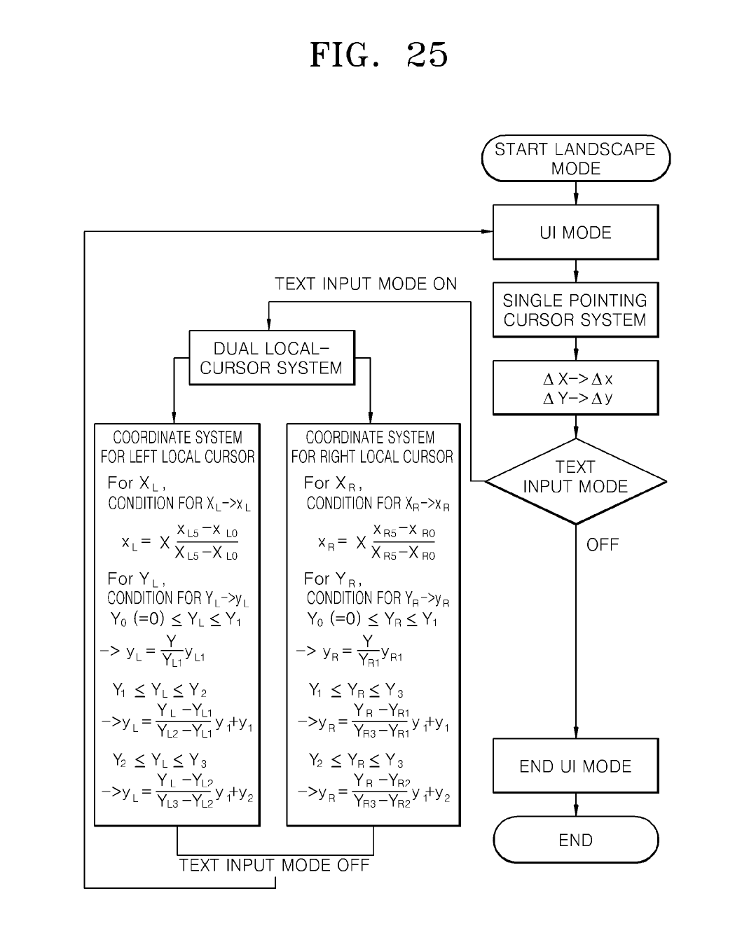

When the heights Δy₁, Δy₂, Δy₃ for rows of virtual keys on the virtual keyboard are the same but vertical widths of high, middle, and low regions of the touchpad corresponding to the row of virtual keys on the virtual keyboard are different to satisfy ΔY₁=ΔY₃<ΔY₂, a method of associating the movement of a cursor and the movement of a finger on the touchpad is shown in FIG. 25.

Y->y conversion is not linear so that when finger position is within ΔY₁ (Y₀≦Y≦Y₁) and ΔY₃ (Y₂≦Y≦Y₃), the cursor position is within Δy₁ and Δy₃, respectively and when finger position is within ΔY₂(Y₁≦Y≦Y₂), the cursor position is within Δy₂.

The advantage of this non-linear relationship is shown in FIG. 24B. That is, when there is the same finger movement, in the case of FIG. 24B-(A) where the central row of virtual keys have the same width (ΔY₁=ΔY₂=ΔY₃), a cursor has a path of ‘a’->‘i’->‘?’. In the case of FIG. 24B-(B) where a central row of virtual keys have larger widths, a cursor has the path of ‘a’->‘k’->‘?’. In the case of FIG. 24B-(B), a finger can be more freely moved in a larger vertical range, and there is an advantage of keeping cursor's trajectory within the middle row.

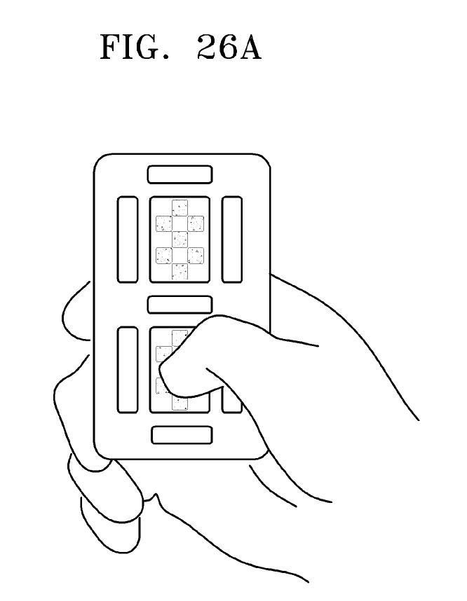

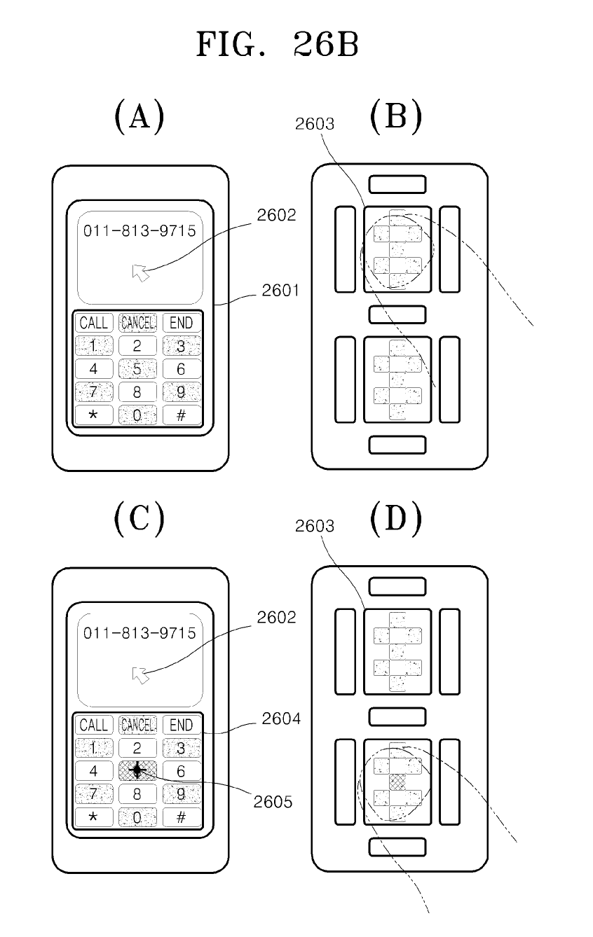

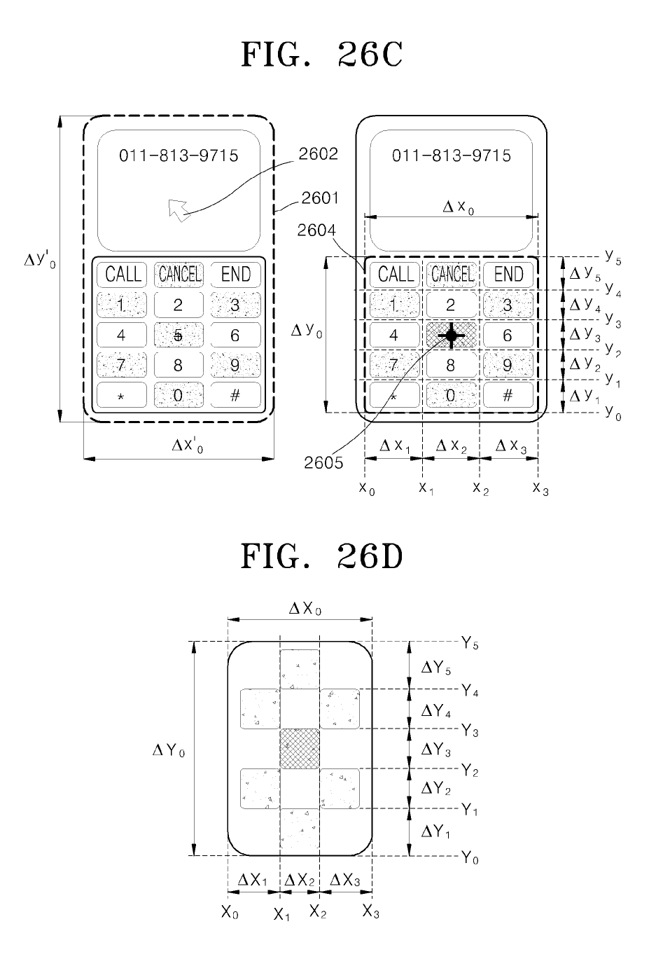

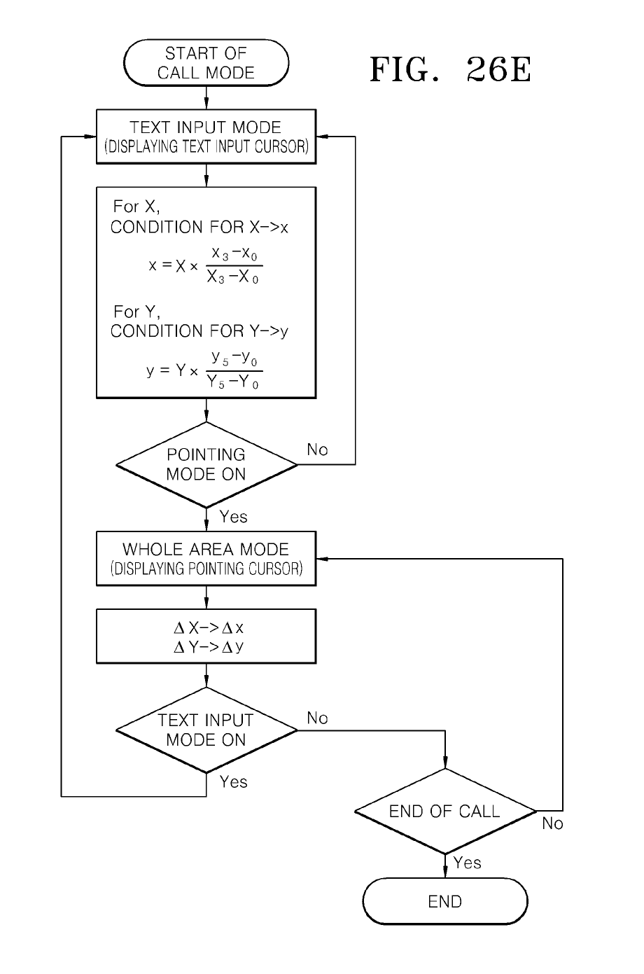

FIG. 26 is an illustration of operating a phone mode with a cellular phone having touchpads of FIGS. 22A-22B in a vertical mode. FIG. 26A illustrates the cellular phone held in a hand and FIG. 26B illustrates the cellular phone changed to a phone mode. When FIG. 26A-26E and FIG. 18 are compared, FIG. 18 illustrates a cellular phone in a vertical mode which is operated in a UI mode that is a whole area mode, and FIG. 18 illustrates the cellular phone changed to a phone mode.

A phone mode starts with a whole area mode. Referring to FIGS. 26B-(A) and 26B-(C), when a finger touches a whole area touchpad 2603, the whole mode is operated to display a whole area cursor 2602 on a screen. A text input mode is operated when a finger touches a text input touchpad 2606, and the cursor 2602 is changed to a text input cursor 2605. Referring to FIG. 26C, the whole area cursor and text input cursor are operated in an entire area 2601 and a keypad area 2604, respectively.

Referring to FIG. 26B, an inactive cursor is not shown while an active cursor is shown. The whole area cursor may be operated by moving the whole area cursor from a position shown in FIG. 26C-(A) to a position in FIG. 26C-(B) where the text input cursor is located in order to select and press ‘5’. That is, the whole area cursor can be used to input letters. However, a touchpad controlling the whole area cursor is different from a touchpad in that it is operated in a relative coordinate system which provides signal corresponding to a displacement (Δx, Δy) while the text input cursor is operated in the absolute coordinate system.

Accordingly, two cursors are used in the phone mode of the present invention. Only the active cursor may be shown on a screen. Or all the two cursors may be shown but operated alternately in a semi-dual cursor method in which active one is distinguished from inactive one by color, shape etc. Although they are operated in different regions and by different touchpads, their functions as pointers are same.

Different brightness or color may be applied to cursors depending on active states or an inactive cursor may be hidden from the screen in order to avoid user confusion. When only one touchpad is used in a vertical mode as shown in FIG. 13C-(C), both a whole area mode and a text input mode may be switched for the same touchpad by pressing a button having a mode converting function.

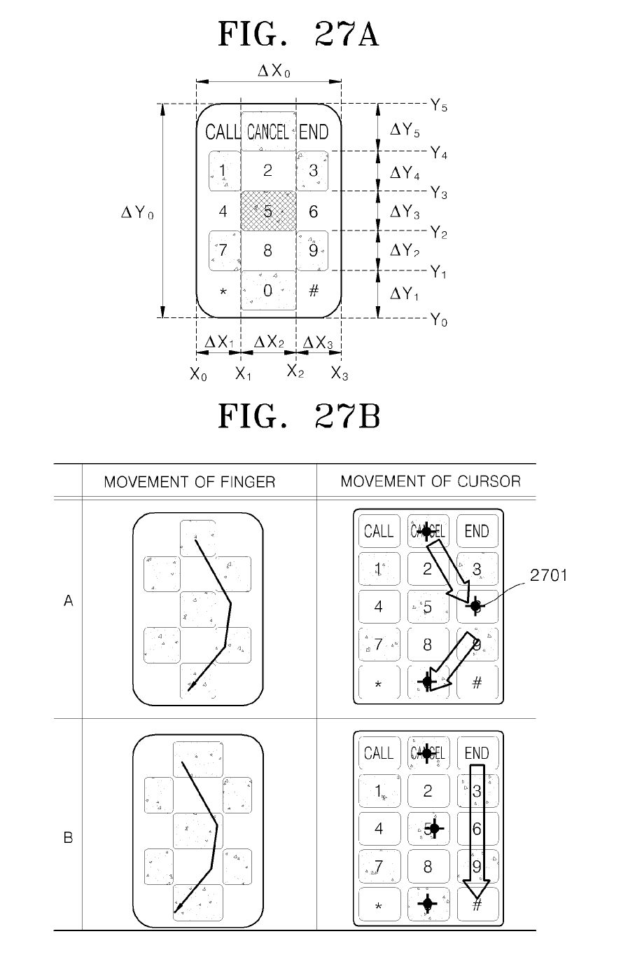

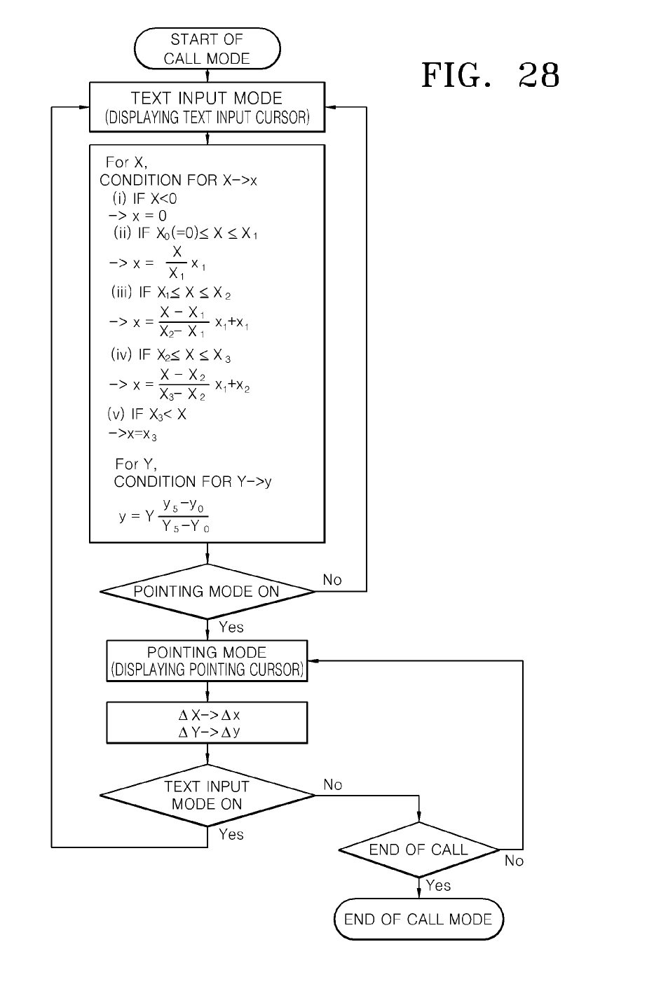

FIGS. 27A-27B illustrate a coordinate system of the touchpad of FIGS. 24A-24B used in a vertical mode. FIG. 28 is a flowchart of a method of calculating coordinates of a cursor.

Unlike in a horizontal mode, in a vertical mode, a finger sways laterally during a vertical movement. To solve the problem, a region ΔX₂ is increased to be larger than regions ΔX₁ and ΔX₃. In this case, even though there is a lateral swaying of a finger during a vertical movement as shown in FIG. 27B, the actual movement of a cursor is confined in region Δx₂ and a stable input can be done.

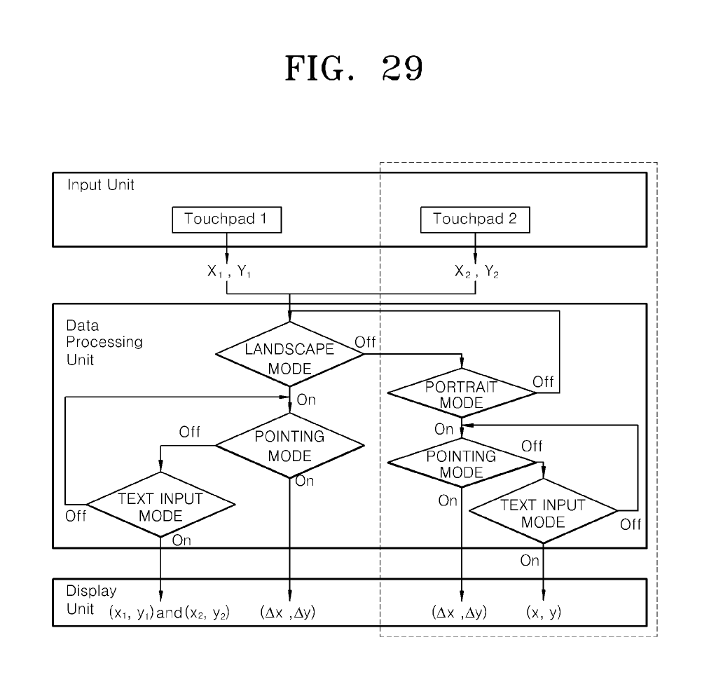

FIG. 29 illustrates a method of displaying cursors on a screen by using signals from two touchpads according to an embodiment of the present invention.

Each of the touchpads generates data (X, Y), and provides the same to a data processing apparatus. In a whole area mode, the data processing apparatus calculates the displacement (Δx, Δy) of a cursor and moves the cursor on a screen. In the text input mode, the data processing apparatus calculates coordinates (x, y) of a text input cursor and moves the text input cursor.

In the text input mode in the horizontal mode, coordinates (x₁, y₁) and (x₂, y₂) of two text input cursors are calculated to move the two text input cursors. However, in a text input mode in the vertical mode, only one text input cursor is displayed. A UI structure marked by a right dotted box is realized for a single touchpad system where only one touchpad is used.

Likewise, in the case of an electronic dictionary laid down on a flat surface and then operated as shown in FIGS. 19A-19D, letters are input by using a virtual keyboard using a UI system of a single touchpad. However, in this case, the UI structure marked by the right dotted box of FIG. 29 is used in the horizontal mode, not in the vertical mode.

Regardless of a cellular phone or an electronic dictionary, since the virtual keyboard input system according to the present invention inputs letters by using an absolute coordinate system of a touchpad, the virtual keyboard input system can work as both a conventional keyboard and a mouse, and can be installed in a small space on a portable electronic device such as a cellular phone or an electronic dictionary.

Division regions on the sensor unit 110 may be defined during manufacture or may be modified by a user. That is, the center point of contact area between a touchpad and a finger of a user may be different from a reference point of the touchpad. Accordingly, the positions of division regions may be modified by reflecting this difference.

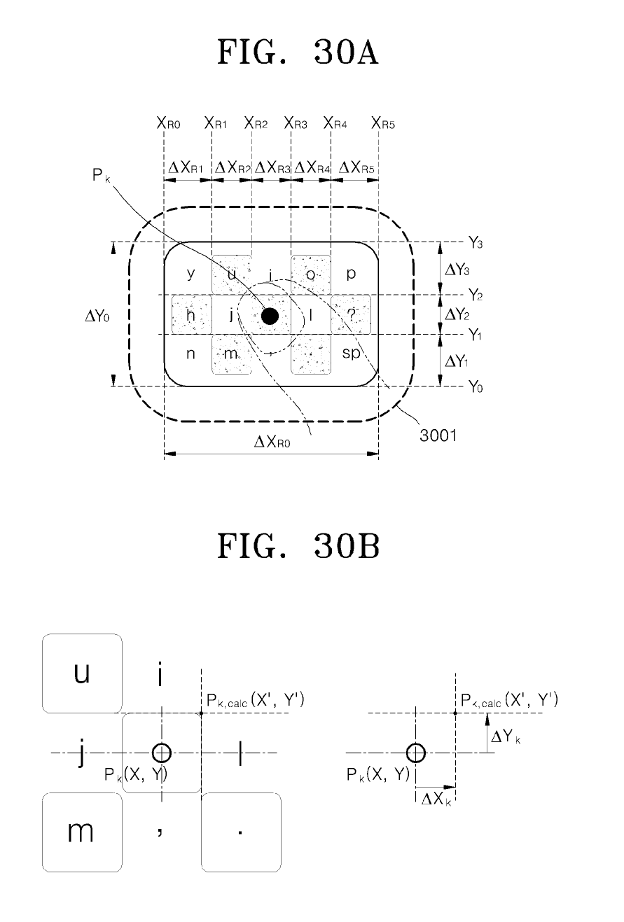

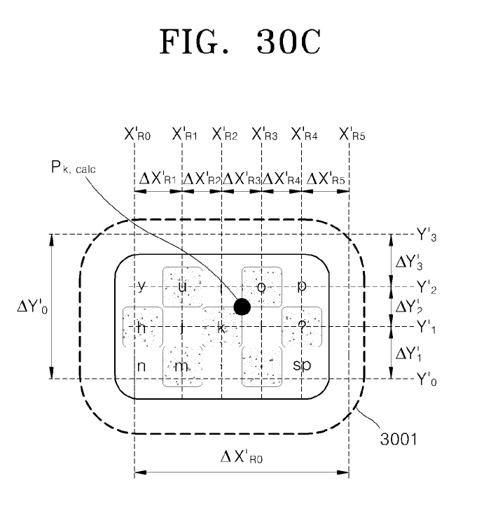

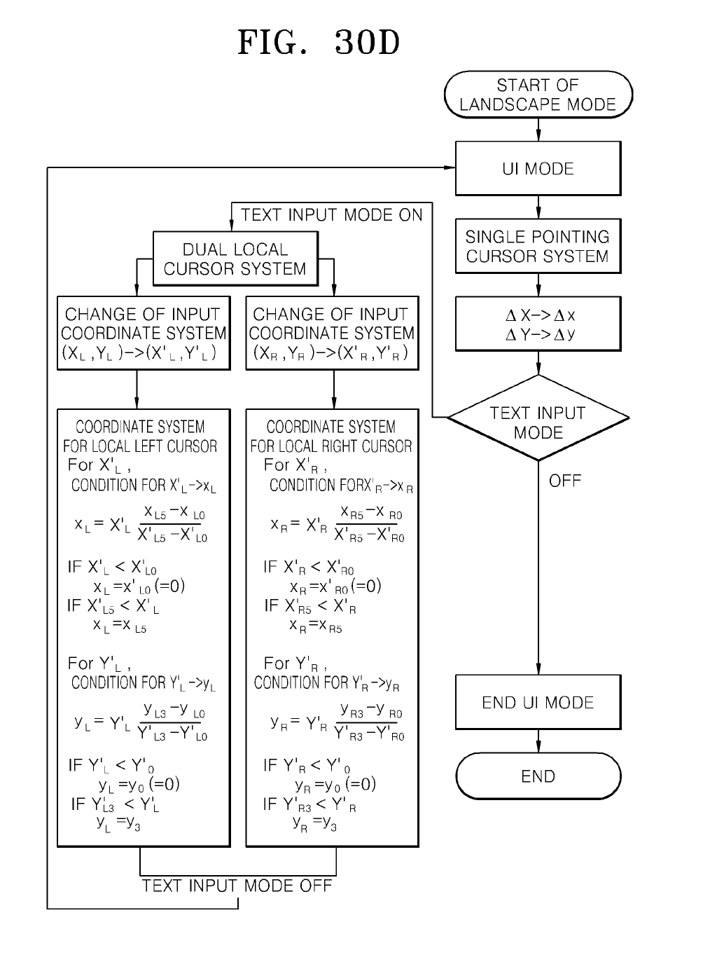

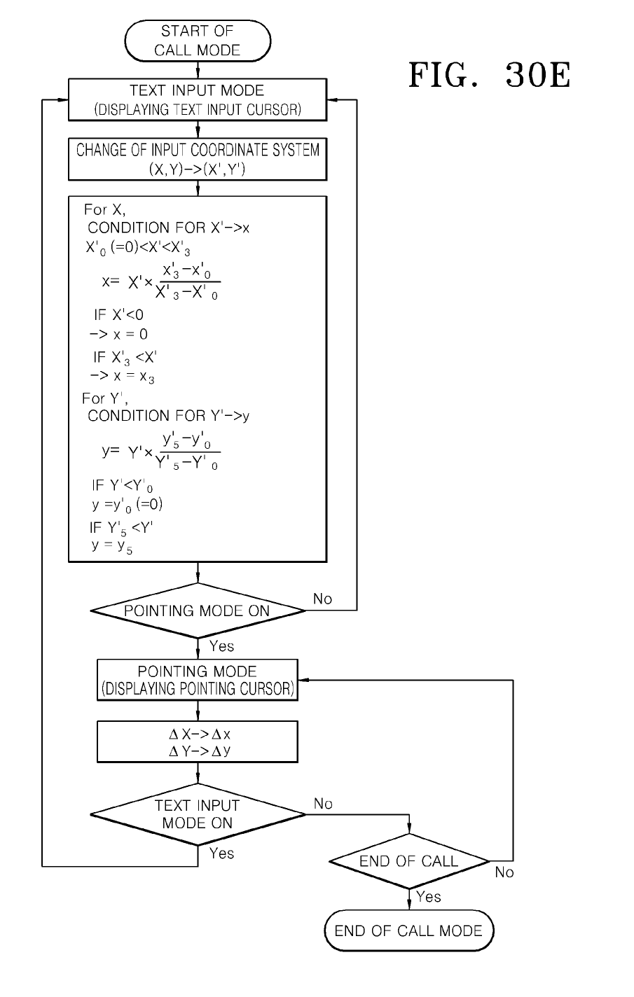

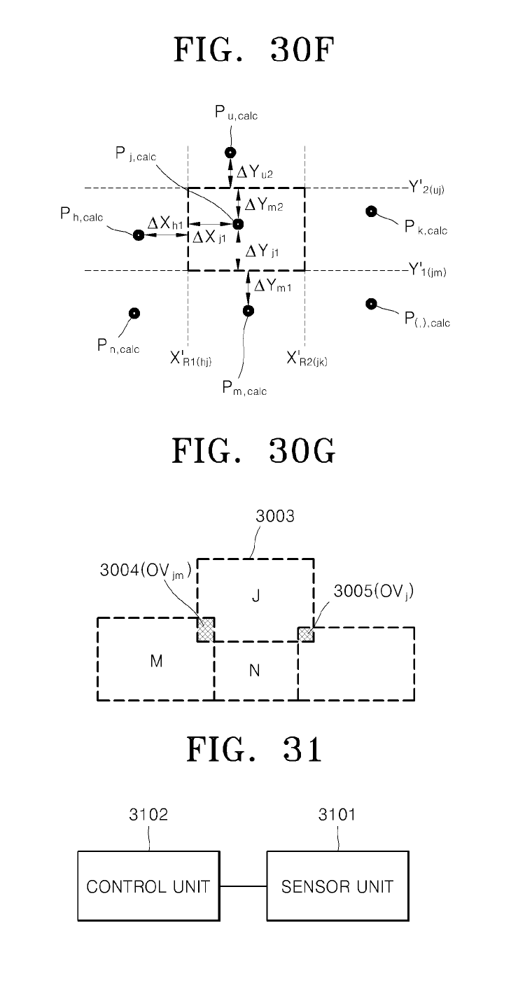

FIGS. 30A-30B are a view for explaining a method of calibrating the mismatch of the center point of contact area between a touchpad and a finger that is placed on a reference point of the touchpad and the reference point.

Referring to FIGS. 30A and 30B, although a finger (thumb) is placed on a reference point Pₖ corresponding to ‘k’ of a virtual keyboard, the center point of the contact area, P_{k,cal} (X′, Y′), which is calculated by the sensor unit, namely touchpad, is different from the reference point Pₖ (X, Y).

This difference arises due to the procedure to calculate the contact point using a change in electrostatic capacity.

That is, when a touchpad utilizes an electrostatic capacity-based method, a contact point (not area) is determined by calculating centroids(X_{centroid}, Y_{centroid}) from electrostatic variation curves in X and Y axes, respectively, which result from the contact between a finger and the touchpad.

However, since people have different shapes of fingers and the contact area and shape also changes, even when people seem to touch the same point, electrostatic capacity curves formed are different depending on people, and accordingly, contact points calculated by a touchpad are different as well.

Accordingly, when coordinates of a cursor is calculated on the basis of the reference coordinate system of FIG. 22A and according to the method of FIG. 23, the cursor is actually placed on a crossing point of ‘i’ ‘o’ ‘k’ and ‘l’ as shown in FIG. 30C, and ‘k’ may not be input on the contrary to a user's expectation.

Accordingly, in order to match P_{k,cal} with the reference point representing ‘k’, the reference coordinate system of the touchpad is moved by the difference (ΔXₖ, ΔYₖ) between Pₖ and P_{k,cal}, a new reference coordinate system (X′-Y′) is set, and P_{k,cal} matches with the reference point representing ‘k’.

This method may be applied to just one reference key (division region) and the result is applied to all virtual keys by moving the reference coordinate system according to the initial calibration. Or by calibration procedure may be applied to some keys which may serve as milestone keys with respect to X and Y axes.

As an example, for the calibration with regard to the X axis, the method may be performed for keys, ‘h’, ‘j’, ‘k’, [symbol] , and ‘?’. The calculated coordinates of the central points for these keys, are used for the calculation of X′_{R1}, X′_{R2}, X′_{R3}, and X′_{R4} shown in FIG. 30C and X′_{R0} and X′_{R5} are extrapolated from X_{R1} and X′_{R4}. Likewise, with respect to the Y axis, the method may be performed for keys, ‘i’, and ‘,’ and the calculated coordinates of these key plus P_{k,calc.} are used in calculating Y′₁ and Y′₂. Y′₀ and Y′₃ are extrapolated from Y′₁ and Y′₂.

Another method will be explained with reference to FIG. 30F. The method sets a region of a touchpad corresponding to each key region on a virtual keyboard in order to match regions of the virtual keyboard with regions of the touchpad because shape of the finger contacting the touchpad and also the contacting area changes depending on the location of a key.

When the regions of the touchpad corresponding to the key regions of the virtual keyboard have uniform heights and widths like a checkerboard as shown in FIG. 30A, the center of a key of the virtual keyboard and that of corresponding key region of the touchpad may not be matched.

Accordingly, the center of each key of the virtual keyboard is set as shown in FIG. 30C, and rectangles formed by drawing horizontal and vertical lines which halves the lines connecting the center point of the key with those of neighboring keys become the key region of the touchpad corresponding to the corresponding key of the virtual keyboard.

For example, a center point P_{j,cal} of a key ‘J’ is set by the method of FIG. 30C, center points (P_{u,cal}, P_{k,cal}, P_{m,cal}, P_{n,cal}) of neighboring keys are set in the same way. A horizontal line (Y=Y′₂₍ᵤⱼ₎, Y=Y′₁₍ⱼₘ₎) and a vertical line (X=X′_{R1(hj)}, X=X′_{R2(jk)}) which halve the lines connecting the center point, P, with central points of the neighboring keys are drawn, and a region 3002 for the key ‘J’ constructed with these halving lines is defined on the touchpad. ΔYᵤ₂ and ΔYⱼ₂ are equal in length since they are distances from the center of keys ‘J’ and ‘U’ to a horizontal line (Y=Y′₂₍ᵤⱼ₎) which bisects the line connecting these center points.

Likewise, ΔYⱼ₁ and ΔYₘ₂, which are distances from the center points of keys ‘J’ and ‘M’ to a horizontal line (Y=Y′₁₍ⱼₘ₎) bisecting the line connecting the central points, are equal in length. Actually, ΔYⱼ₁ and ΔYⱼ₂ may be different from each other, and in this case, a central point Pj of ‘J’ may not be the center of the rectangle 3002.

For the X axis as in the Y axis, ΔXₕ₁ and ΔXⱼ₁, which are distances between the center points of keys ‘H’ and ‘J’ to a vertical line (X=X′_{R1(hj)}) bisecting the line connecting the center points, are equal in length. Referring to FIG. 30G, key regions formed in this way have overlapping regions 3004 and 3005, unlike the checkerboard-like regions of FIG. 30A. That is, the region 3004 Ovⱼₘ is constructed because the key regions for ‘J’ and ‘M’ overlap, and the region 3005 Ovⱼ is formed because the key regions for ‘J’ and ‘,’ overlap. The overlapping regions 3004 and 3005 are invalid regions to which corresponding keys are not assigned and thus the keys are assigned to the other regions excluding these overlapping regions.

That is, ‘J’ is input when the center of a finger is located on a rectangle region 3003 which excludes the overlapping regions 3004 and 3005.

A method of calculating coordinates of a cursor in a horizontal mode and a vertical mode (phone mode) on the basis of a new reference coordinate system (X′-Y′) is shown in FIGS. 30D and 30E.

In FIGS. 30D and 30E, an operation which is represented by ‘changing an input coordinate system’ means the operation changing from a nominal reference coordinate system (X-Y) of FIG. 30A to an acting reference coordinate system (X′-Y′) of FIG. 30C.

FIG. 31 is a block diagram of a virtual keyboard input system according to another embodiment of the present invention.

The virtual keyboard input system of FIG. 31 is different from the virtual keyboard input system of FIG. 1 in that a sensor unit 3101 acts as a switch unit. That is, the sensor unit 3101 senses a pressure and determines whether to perform a switch function according to the pressure, thereby making a separate switch unit unnecessary.

Except for the fact that the sensor unit 3101 performs a switch function and thus a switch unit is not necessary, the virtual keyboard input system of FIG. 31 is identical to the virtual keyboard input system of FIG. 1. Hence the various embodiments derived for the virtual keyboard input system of FIG. 1 may be applied to the virtual keyboard input system of FIG. 31.

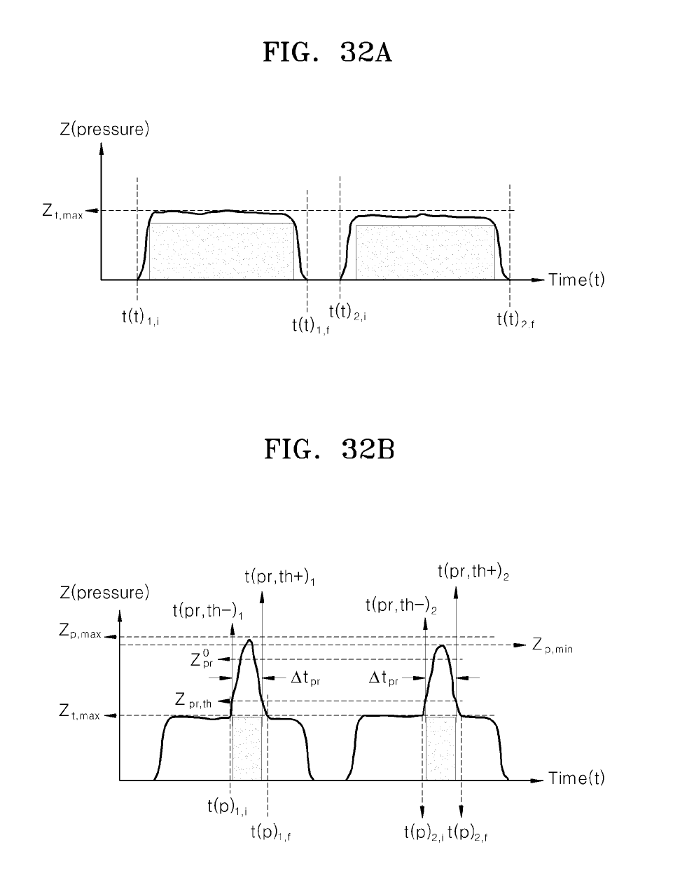

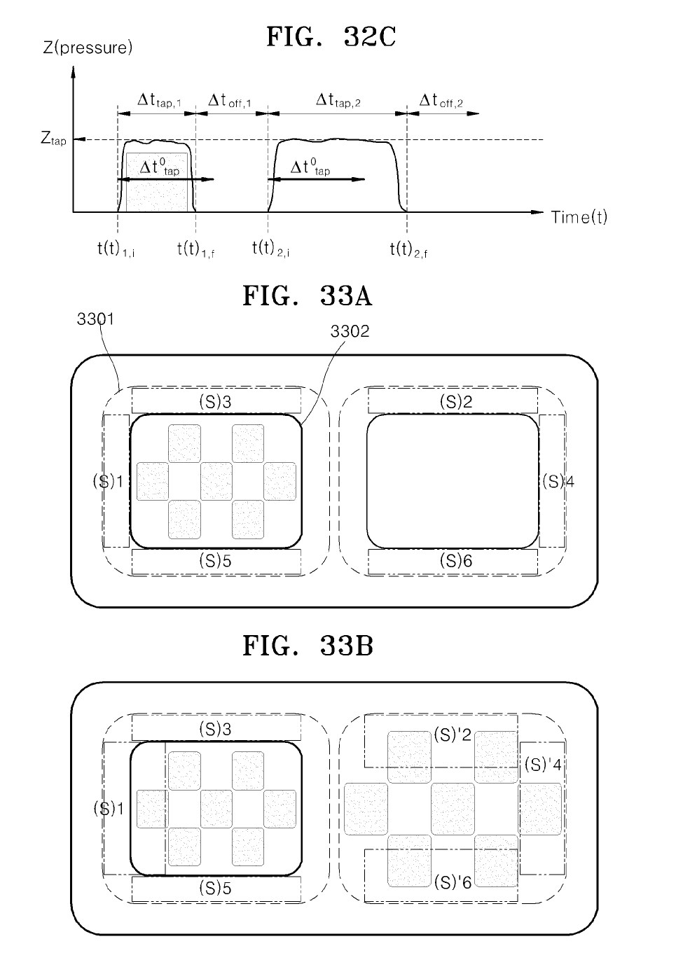

How the sensor unit 3101 performs a switch function will be explained with reference to FIGS. 32A-32C.

FIGS. 32 A-32C illustrate three types of pressure change during a contact of a finger with the touchpad when a touchpad functions other than a pointing.

In detail, FIG. 32A illustrates a pressure change during a conventional pointing operation. FIG. 32B illustrates a pressure change during a pressing operation. FIG. 32C illustrates a pressure change during a tapping operation.

When a finger applies a pressure to the touchpad, the area of the finger contacting the touchpad is increased and the electrostatic capacity of the touchpad is changed. Hence a change in pressure is calculated by using the change in electrostatic capacity.

Referring to FIG. 32A, when a finger moves on the touchpad for a pointing job, there is a small change in pressure. However, referring to FIG. 32B, when a pressing is performed, the pressure is increased to Z_{p,max} that is higher than Z_{t,max} (pressure at touch).

Accordingly, if the sensor unit 3101 performs a switch function when the pressure is higher than a pressing reference pressure Z^{o}ₚᵣ, the switch unit of FIGS. 2 and 4 which performs a pressing function may not be necessary.

Here, a pressing reference pressure may be a pressure arbitrarily set by a user between a minimum pressure Z_{p,min} which is generated when the user presses the touchpad and a touch pressure, so that the sensor unit 1301 can perform a switch function with even a minimum pressure Z_{p,min}.

Switch-on time when a switch function is turned on may be determined by a time point when a measured pressure is greater than a pressing reference pressure, or may be determined by using a pressing threshold pressure Z_{pr,th} that is another constant.

The pressing threshold pressure Z_{pr,th}, which is slightly greater than the touch pressure Z_{t,max}, is given by

Z_{pr,th}=Q_{pr,th}(Z^{o}ₚᵣ−Z_{tch})+Z_{tch} (1)

where Q_{pr,th} is a proportional constant designated by the user and is in a range of 0.5<Q<0.9. Z^{o}ₚᵣ and Z_{tch} are set during the initialization of the touchpad. Z_{tch} is a maximum touch pressure which is measured while a user moves a finger freely over the touchpad, and Z^{o}ₚᵣ is nominal value which is set slightly lower than a minimum pressing pressure Z_{p,min} measured while the user presses a designed region as usual, preferably, 90% of Z_{p,min}. But this ratio can be arbitrarily determined by the user so that Z^{o}ₚᵣ be greater than Z_{pr,th}.

A switch-on duration time for which the switch function is turned on may be determined by using such a pressing threshold pressure. The switch function may be turned on at t_{pr,th-} when a pressing pressure reaches a pressing threshold pressure after a pressing starts, and the switch function may be turned off at t_{pr,th+} when a pressing pressure reaches again a pressing threshold pressure after the pressure increases above a pressing reference pressure Z^{o}ₚᵣ. The time interval for which the pressure is above the pressing threshold pressures with its maximum pressure higher than Z^{o}ₚᵣ may be defined as the actual pressing time Δtₚᵣ.

The reason why both the pressing reference pressure and the pressing threshold pressure are defined is that if only one pressure value is set, lots of force is required to maintain a pressing operation in the case of reference pressure with high value. As a reverse case, if the reference pressure is too low, slight touch may be recognized as a pressing action and the switching becomes on.

On the contrary, when both the pressing threshold pressure and the pressing reference pressure are used as switching criteria, the user needs to apply high pressure for a short time in order to maintain a pressing operation, and apply low pressure for the rest of the pressing time, which is a little bit more than the touch pressure (Z_{t,max}) while a switch function should be turned on, thereby preventing the waste of force.

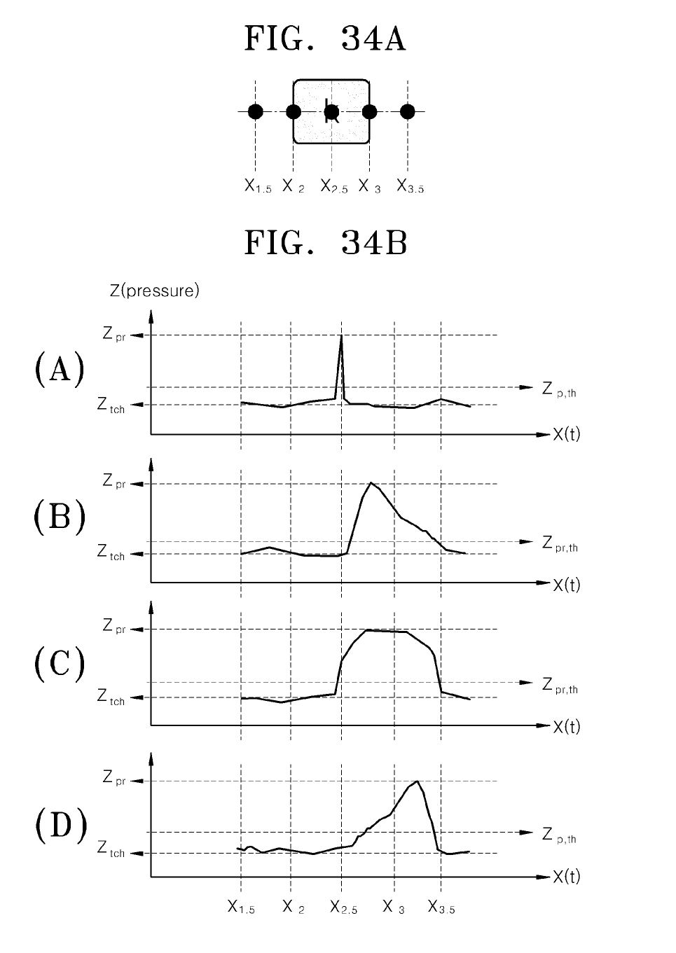

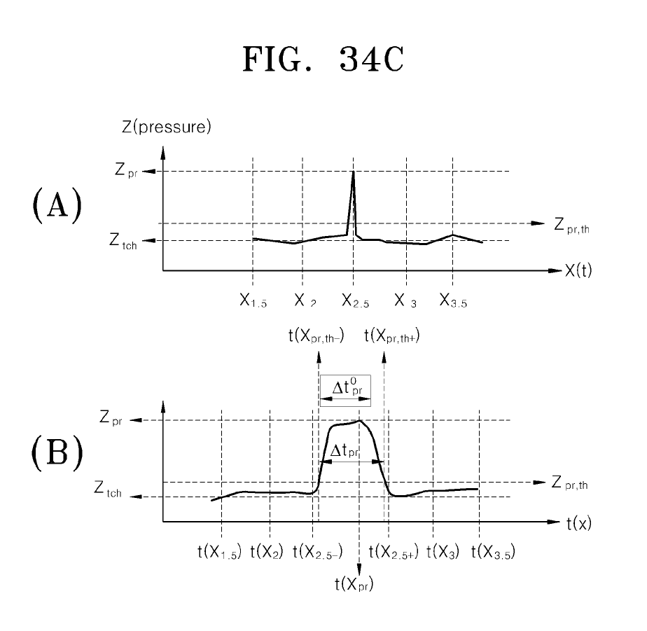

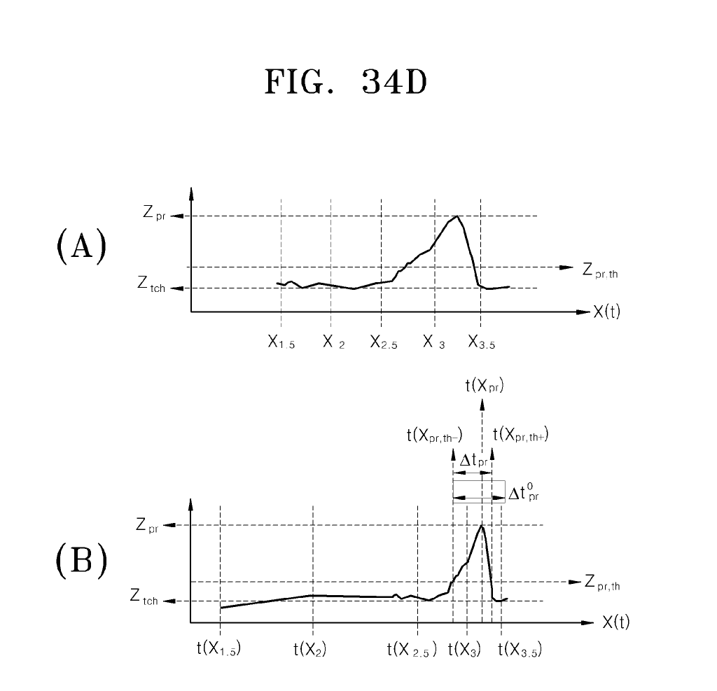

A pressing threshold pressure is also used to correct a text input error which will be explained with reference to FIGS. 34A-34D in detail.

In general, a touchpad used in a notebook computer already performs the function of a function button by tapping. FIG. 32C illustrates a pressure change when the touchpad is tapped.

Referring to FIG. 32C, when a maximum pressure generated during a tapping operation is defined as Zₜₐₚ, the tapping pressure may be equal to the touch pressure or the pressing pressure. However, since tapping is recognized not by the magnitude of the pressure but by touching interval, tapping can be prevented from being recognized as pressing or touching action.

That is, referring to FIG. 32C, when a touch-on duration Δtₜₐₚ and a touch-off duration Δt_{off} are repeated within a predetermined time under conditions of Δt(t)₁<Δt^{o}ₜₐₚ and Δt(o)₁<Δt^{o}ₜₐₚ for double clicking, where Δt^{o}ₜₐₚ is a tapping reference time designated by a user, a tapping function is executed irrespective of a pressing pressure.

When a finger accidentally touches the touchpad, a touch-on duration Δt_{tap,2} is longer than a tapping reference time Δt^{o}ₜₐₚ(Δt_{tap,2}>Δt^{o}ₜₐₚ) or a touch-off duration Δt_{off,2} is longer than the tapping reference time (Δt_{off,2}>Δt^{o}ₜₐₚ), thereby preventing the accidental touching from being wrongly recognized as tapping.

Referring to FIG. 32C, when a touch duration Δt_{tap,1} and a touch duration Δt_{tap,2}—are consecutive, another switch function may be performed. This is already used in a conventional touchpad that is used as a pointing device and a function button as well by double tapping (clicking).

In this case, although Zₜₐₚ may be greater or less than Z_{p,max} or Z_{p,max}, it does not matter. It is important to know whether the touchpad is touched or not by accident or intended action on the basis of the duration of touch and touch-off and its change with time.

That is, if a switch function is defined by setting the ranges of t_{tap,1}, Δt_{off,1}, and Δt_{tap,2}, and checking operation for a tapping is processed before that for pressing, a tapping pressure higher than a pressing reference pressure, tapping is not recognized as a pressing.

When a tapping function is performed by using a change in electrostatic capacity over time in this way, the touchpad can serve as a switch unit, and thus the function buttons 1201, 1202, and 1203 of FIG. 12A may not be necessary. If those function buttons 1201, 1202, and 1203 are removed, they may be assigned other functions which is desirable result.

FIGS. 33A-33B illustrate touchpads 3301 having a tapping function which replace the function of function buttons of FIGS. 32A-32C.

Although a tapping function and a pressing function are divided by a touch-off time as described above with reference to FIGS. 32A-32C, when pressing regions 3302 and tapping regions (S)1 through (S)6 of the touchpads 3301 are mechanically separated, even a strong pressure applied during tapping by mistake in longer time than the tapping reference time, does not cause a pressing state to be on.

Referring to FIG. 33A, since the separate tapping regions (S)1, (S)2, (S)3, (S)4, (S)5, and (S)6 around the pressing regions 3302 are covered with a cellular phone body, the touchpad 3301 is prevented from being pressed during tapping and a tapping operation can be freely performed.

As described above, however, pressure duration patterns for tapping and pressing are theoretically different from each other.

Accordingly, without separating the tapping regions (S)1, (S)2, (S)3, (S)4, (S)5, and (S)6 from the pressing regions 3302, embossed regions as shown in a right touchpad of FIG. 33B may be expanded to edges of the touchpad, thereby increasing the region for each key of the virtual keyboard.

That is, switch regions operated by tapping in a touchpad region may overlap with regions for virtual keys.

In this case, each region can be easily perceived and make letter be easily input and tapping regions (S)′2, (S)′4, and (S)′6 may be maintained even though the regions for the virtual keys are increased. Furthermore, there is no need to reduce the thickness of a part of the phone body corresponding to the tapping regions (S)1, (S)2, (S)3, (S)4, (S)5, and (S)6 of FIG. 33A.

Even when a switch unit for inputting information corresponding to a selected virtual key as shown in the above embodiment is disposed separately from the touchpad, if the method of the right touchpad of FIG. 33B is used, some functions can be performed with only a part of the sensor unit 1301 without using separate hardware.

However, when a separate switch unit for inputting information corresponding to a selected virtual key as shown in the above embodiment is disposed along with the separate tapping regions (S)1, (S)2, (S)3, (S)4, (S)5, and (S)6 as shown in FIG. 33A for sensing contact by using a change in electrostatic capacity, a switching operation can be performed with just a pressing operation at a pressure greater than the pressing reference pressure without considering a tapping operation. However, in the case of the right touchpad of FIG. 33B, a switching operation must be performed with only an well defined pressing operation, which is different from ordinary touch or the like, such as a tapping operation in order to distinguish it from the inputting operation of a virtual key.

When a switching is run by measuring a pressing pressure on a touchpad or a touchscreen which is used as the sensor unit 3301, the position of finger on the input key may be changed during pressing although the user's finger contacts a correct position on the touchpad for the key to be input before pressing it.

Besides, even when a pressure switch as shown in FIGS. 2 and 4 is pressed or a separate switch as shown in FIG. 13B is pressed, the contact position of a finger may be changed due to the movement of the finger around finger's joints.

A method of correcting an error which may occur like above will now be explained with reference to FIGS. 34A-34D.

FIGS. 34A-34D illustrate an error occurring when a touchpad functions as a function button on the basis of a pressure change during a pressing operation. A process of placing a finger on ‘k’ of the touchpad and pressing ‘k’ in order to input ‘k’ will be exemplarily explained.

Referring to FIG. 34A, let's assume a part of the touchpad is divided to X1.5˜X3.5. And the touchpad is pressed when the finger is on the position for key ‘k’ while the finger moves from ‘j’ to ‘l’. A pressure change occurring in this process is so shown in FIG. 34B. The most desirable pressure change is shown in FIG. 34B-(A) but other pressure changes shown in FIGS. 34B-(B) through (D) may occur.

Referring to FIG. 34B-(D), a pressure is applied while the finger is in the ‘k’ region, but a maximum pressure is reached when the finger is in the ‘l’ region. Accordingly, a desired letter to be input by the user may be different from the actually input letter.

A pressing threshold pressure Z_{pr,th} is introduced to solve this problem. As described already, the pressing threshold pressure Z_{pr,th} may be determined between a pressing reference pressure Z^{o}ₚᵣ and a touch pressure Z_{tch} by considering the user's habit.

FIG. 34B illustrates four cases that may occur during a pressing operation. In FIG. 34B, a pressure change is plotted with the X coordinate on the horizontal axis. FIG. 34B-(A) illustrates the most desirable pressure change. FIG. 34C is a detailed view illustrating a pressure change with time(T), FIG. 34C-(A) and X coordinate, FIG. 34C-(B).

Referring to FIG. 34C-(A), when a pressure is applied with a finger contacting the same position of the touchpad, there is a peak at X2.5 in which case it is not easy to see variation of pressure in detail. Referring to FIG. 34C-(B), in which pressure change is plotted with time, pressure begins to be applied at t(X₂₅₋), reaching its maximum at t(Xₚᵣ), and a normal touch pressure Z_{tch} is reached at t(X_{2.5+}).

That is, since there exist two points where the threshold pressure is reached before and after a maximum pressure is reached, the present invention uses this fact to correct an error which may occur during an input process. In a desirable pressing process, two points X_{pr,th-}, and X_{pr,th+}, which are threshold pressure points right before and after Xₚᵣ, respectively. They are located in the ‘k’ region (X₂<X<X₃). However, in the case of FIG. 34B-(C), X_{pr,th-} belongs to the ‘k’ region but X_{pr,th+} belongs to the ‘l’ region, and Xₚᵣ, which determines the region to which the letter to be input is assigned, also is in the ‘l’ region.

Accordingly, in the cases of FIGS. 34B-(C) and 34B-(D), ‘l’ is input instead of ‘k’. In order to avoid this error, a letter corresponding to X_{pr,th-}, not a letter corresponding to Xₚᵣ, must be input.

According to the present invention, an error is corrected by determining a pressing threshold pressure Z_{pr,th}; when a pressing pressure Zₚᵣ reaches a pressing reference pressure Z^{o}ₚᵣ, a letter V(X(Z_{pr,th-})) corresponding to the pressing threshold pressure

Z_{pr,th-} is compared with a letter V(Z^{o}ₚᵣ) corresponding to the pressing reference pressure, and input V(Z^{o}ₚᵣ) if the letters V(X(Z_{pr,th-})) and V(Z^{o}ₚᵣ) are the same or otherwise input V(X(Z_{pr,th-})).

That is, in any case, since V(X(Z_{pr,th-})) is input. Accordingly, V(X(Z_{pr,th-})) is always input according to the present invention. Hence, even in the case of pressure variation shown in FIG. 34B-(D), what is intended to be input by a user can be input.

There seems a problem in that since the averaged pressing pressure is substantially reduced, the touch pressure Z_{tch} may exceed pressing threshold pressure Z_{pr,th}.

Even in this case, if the user has no intention, the touch pressure Z_{tch} may not reach the pressing reference pressure Z^{o}ₚᵣ and an accidental input of letter may not happen.

Accordingly, the setting of the pressing threshold pressure reduces the overall text input pressure, prevents a text input error during a normal touch operation, and enables the intended letter to be accurately input.

When a method of varying the brightness or color of the region of the letter corresponding to a position indicated by the text input cursor as the text input cursor moves on a virtual keyboard is added to the text input error correction scheme, a user can easily perceive the position of the text input cursor and it can be much easier to input letter. Furthermore, if the region of the letter to be input is changed to another color during the input action, it will make error correction much easier.

The pressing threshold pressure introduced to accurately input letters can be used for another function. That is, the pressing threshold pressure may be used for a second additional function of the keyboard.

FIG. 34C-(B) is a detailed view illustrating a pressure change according to a time and an X coordinate. Referring to FIG. 34C-(B), a letter is input when a pressing pressure is reduced below a pressing reference pressure and reaches a pressing threshold pressure again (X=X_{pr,th+}), not when a pressing pressure reaches a pressing reference pressure.

This is because when a pressing duration (Δtₚᵣ=t(X_{pr,th+})−t(X_{pr,th-}) in which the pressure is kept greater than the pressing reference pressure is longer than a determined pressing reference time Δt^{o}ₚᵣ, a space or shift key can be input after a virtual key is input as a second additional function for the virtual keyboard.

For example, referring to FIG. 15B, a shift-key function button needs to be pressed to change a small letter scheme to a capital letter scheme or vice versa. To do the same work, the pressing reference time is defined to a certain value and a pressing pressure is maintained more than this time interval, the shift-key function may be performed. In the same token, Z_{pr,th-} and Z_{pr,th+} are in charge of a switch-on function and a switch-off function, respectively.

Accordingly, when a shift key function is performed according to a pressing duration, it is not necessary to press the shift-key function button. However, when second virtual keys corresponding to capital letters need to be used continuously, it is convenient to use the function button to operate a caps-lock function.

Also, the function of the caps-lock key may be performed by tapping the tapping regions (S)1, (S)2, (S)3, (S)4, (S)5, and (S)6 outside the touchpads of FIG. 33A.

Accordingly, when the second virtual keys corresponding to the capital letters need to be used continuously, the shift function may be maintained by using the caps-lock function button, and when capital letters, such as first letter in a sentence, need to be used occasionally, the shift function may be performed by maintaining a pressing pressure.

How to use the pressing reference time is shown in FIGS. 34C-(B) and 34D-(B). FIG. 34C-(B) illustrates an example where ‘K’ is input and FIG. 34D-(B) illustrates an example that ‘k’ is input.

That is, in FIGS. 34C-(B) and 34D-(B), a pressing reference time Δt^{o}ₚᵣ is gray colored. Referring to FIG. 34C-(B), a pressing time Δtₚᵣ is longer than the pressing reference time Δt^{o}ₚᵣ (Δtₚᵣ>Δt^{o}ₚᵣ) ‘K’ is to be input. Referring to FIG. 34D-(B), a pressure time Δtₚᵣ is shorter than the pressing reference time Δt^{o}ₚᵣ (Δtₚᵣ<Δt^{o}ₚᵣ), ‘k’ is to be input. In either case, what is to be input is the key which represents the key region of the pointer at an initial pressing threshold pressure Z_{pr,th-}.

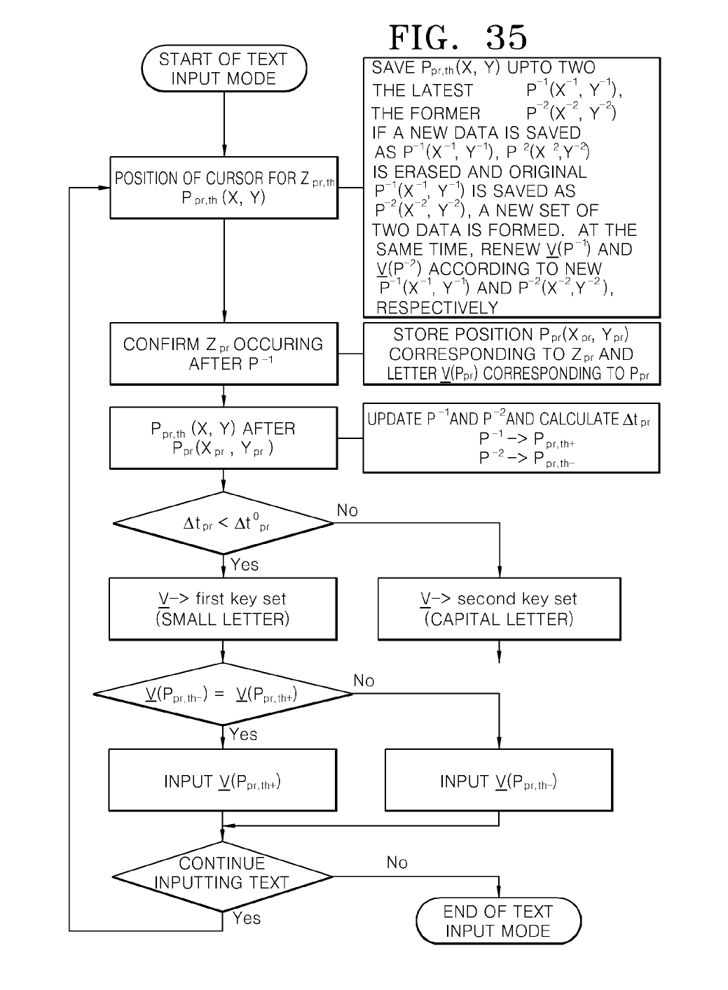

FIG. 35 is a flowchart illustrating the method of correcting letters according to an embodiment of the present invention.

Although the function of a text input switch controlled on the basis of the pressure to a touchpad is explained, the same controlling scheme may be applied to inputting letters with mechanical switches as shown in FIGS. 2, 4, and 13B-13D.

That is, t(X_{pr,th-}) and t(X_{pr,th+}) shown in FIGS. 34A-34D correspond to a switch-on time tₒₙ and a switch-off t_{off}, respectively and is utilized in identifying an input letter. That is, if V(tₒₙ) and V(t_{off}) which represent letters when a mechanical switch is turned on and turned off, respectively, are the same, V(t_{off}) is input, and if they are different, V(tₒₙ) is input.

Likewise, even when a mechanical pressure switch as shown in FIG. 2, 4, or 13B-13D is used, the same text input correction method using a pressing pressure may be applied. When the mechanical switch is turned on, a pressing pressure should be applied to the touchpad and pressing threshold pressure time t(X_{pr,th-}), is earlier than tₒₙ which represents a point of time when the mechanical switch is turned on. Hence V(tₒₙ) is replaced by V(t(X_{pr,th-})) in the correction scheme explained above. If V(t_{off}) and V(t(X_{pr,th-})) are equal to each other, V(t_{off}) is input and when V(t_{off}) and V(t(X_{pr,th-})) are different from each other, V(t(X_{pr,th-})) is input. This may be provided as an optional program which is best fit to the user's pressing pattern.

Although the virtual keyboard input system according to the present invention is characterized in that a virtual keyboard based on an absolute coordinate system and a two-dimensional pointing device are used to input information of a virtual key assigned to a division region when a corresponding point is pressed or contacted, the present invention is not limited thereto. And it is possible that when a contacting position is moved within a preset time according to a predetermined pattern, a corresponding function or letter may be programmed to be input.

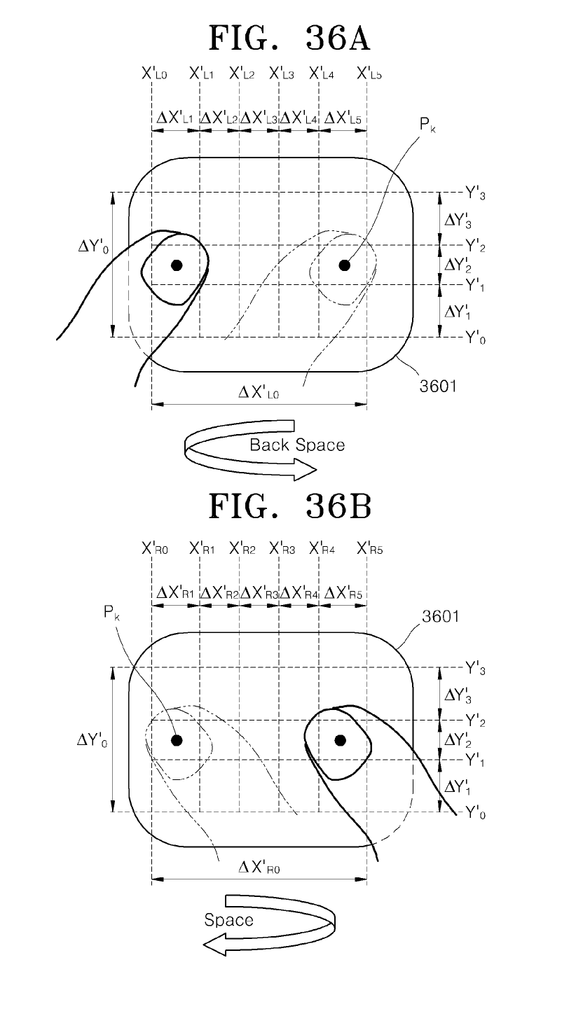

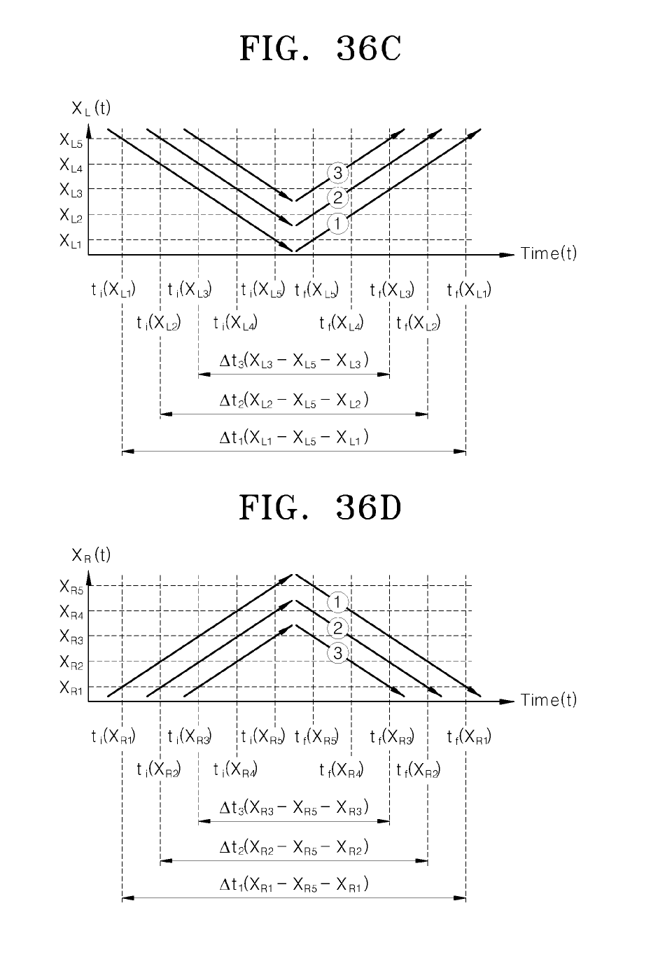

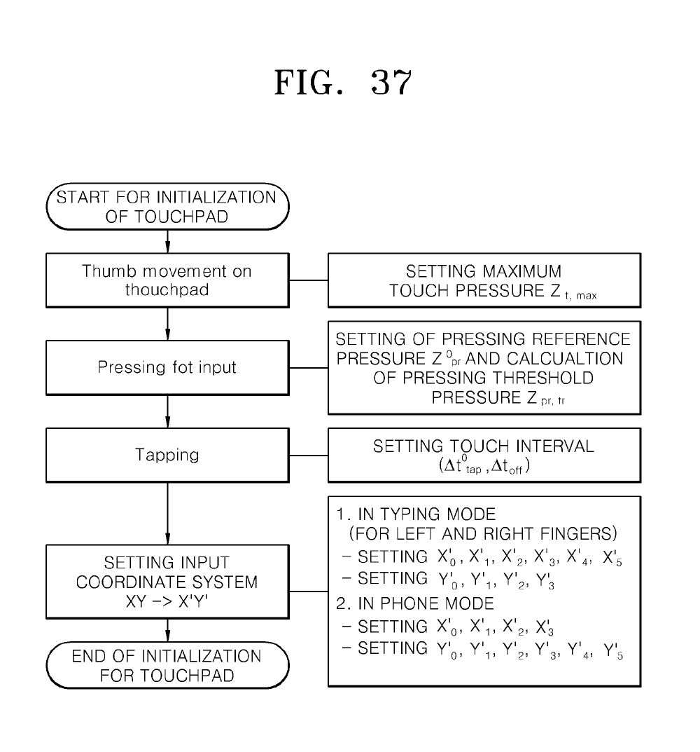

FIGS. 36A-36D are illustrations explaining a method of inputting ‘space’ and ‘backspace’ which are most frequently input in a text input mode.

‘space’ and ‘back space’ may be input by selecting a ‘space’ key on a virtual keyboard by using a switch function, but in the present embodiment, can be input when a finger is laterally moved over a touchpad in the horizontal direction.

That is, a finger moves laterally during inputting text in general. However, as shown in FIG. 36A, the movement of a finger which goes fast back and forth or vice versa does not happen except for the cases to deliberately input a special letter or perform a special function as in the present invention.

Accordingly, such a deliberate movement is set in advance and if it is sensed while a virtual keyboard is used, the corresponding function may be performed or a corresponding letter may be input. This will help inputting work become easy.

Since a thumb operating a left touchpad is usually positioned to the right side from the center of the touchpad, a movement of right->left->right is convenient, and since a thumb operating a right touchpad is usually positioned to the left side from the center, a movement of left->right->left is convenient. Accordingly, when a space function and a back space function are defined on the basis of this movement scheme, letters can be easily input.

For this, a data processing unit as shown in FIG. 29 stores points of time when the reference coordinates X₁, X₂, X₃, X₄, and X₅ are passed and executes a space or a back space function when the trajectory of finger's movement matches those paths shown in FIGS. 36C and 36D.

Paths \textcircled{1}, \textcircled{2}, and \textcircled{3} may be followed for actually inputting letters. However, although a finger follows those paths, the space or back space function is executed only when time segment Δt₁, Δt₂, and Δt₃ during which a finger follows the paths \textcircled{1}, \textcircled{2}, and \textcircled{3} are less than the preset time t_{space} in order to distinguish an intended movement of a finger to input a space or a back space from ordinary movement of a finger on the touchpad. One of Δt₁, Δt₂, and Δt₃ may be selected according to a user's input pattern or convenience.

For a function which is performed when a preset patterned movement is observed within a preset time, a movement pattern, a time, an assigned function, and the like may be set by the user in advance.

FIG. 37 is a flowchart illustrating the method of initializing a touchpad which will perform the function of a function button. A maximum touch pressure, which is determined by a contact area between a finger and a touchpad is first set for the user since the size of a finger is different for a different user and then a pressing reference pressure and a pressing threshold pressure are sequentially set.

Thereafter, a touch-off time for performing the function of a function button by tapping is set. Then a touchpad coordinate system explained with reference to FIGS. 30A-30G is set in a horizontal mode and a vertical mode to define a new coordinate (X′-Y′) which will be used in calculation of coordinates of a cursor in a text input mode.

The pressing reference pressure and the pressing threshold pressure may be set according to the position on the touchpad.

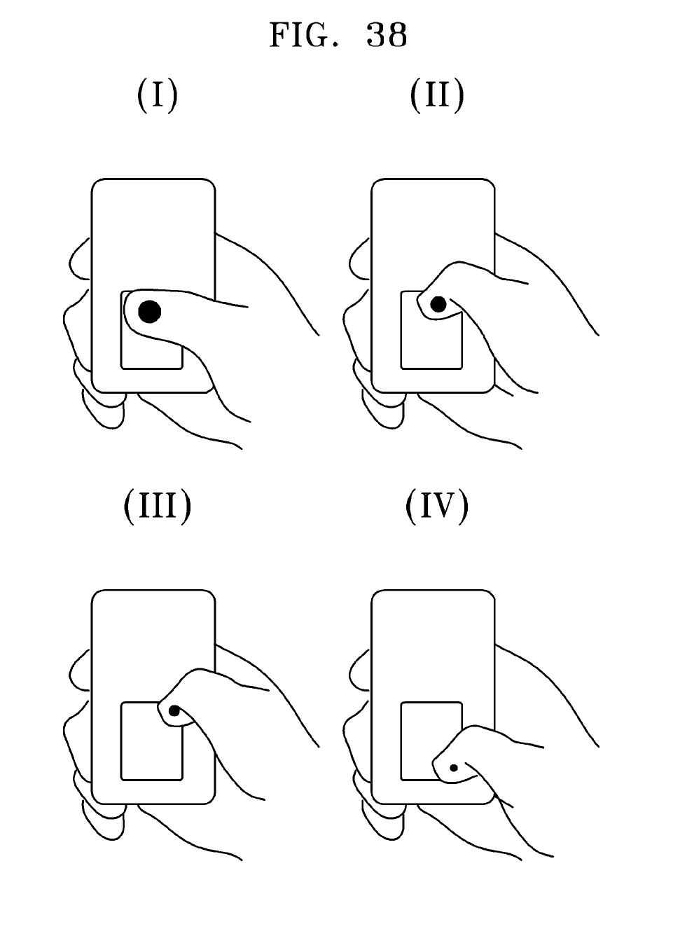

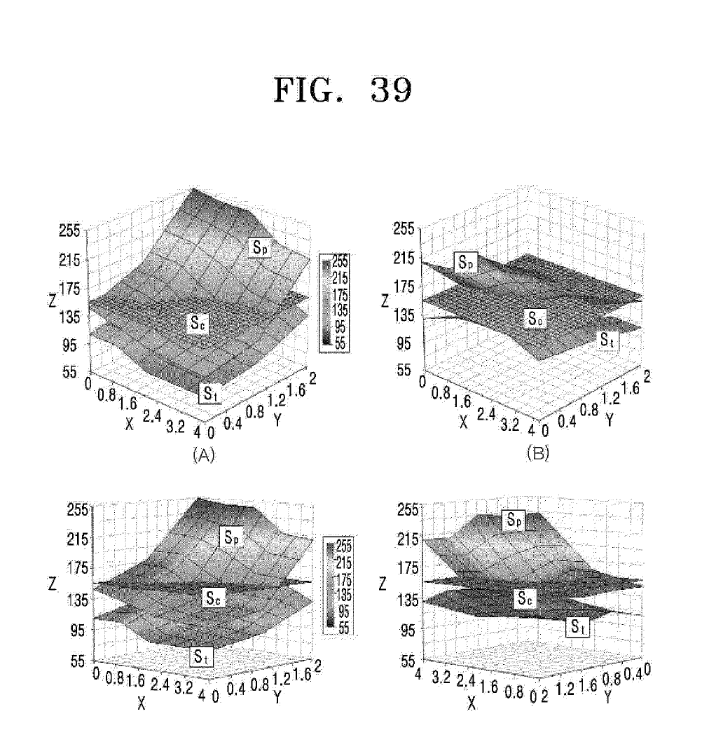

FIG. 38 illustrates contact areas between a finger and a touchpad which varies depending on positions of the finger on the touchpad.

When a user is right-handed and presses left upper region of the touchpad as shown in FIG. 38-(I), the entire area of the thumb is used, but when the user presses a right lower region as shown in FIG. 38-(IV), a contact area is smaller than that for the case of FIG. 38-(I) since the thumb is raised and pressed.

Since the electrostatic capacity of the touchpad used to calculate a contact occurrence and magnitude of pressure increases in proportion to an area, even when the user presses the touchpad with the same force as in the case of FIG. 38, the electrostatic capacity of the left upper end of the touchpad is higher than that of the right lower end of the touchpad.

Accordingly, when a pressing reference pressure and a pressing threshold pressure have a constant value for all the area of the touchpad, a switch function may not be performed although the user presses the touchpad with the same force.

On the contrary, even when the user slightly touches the touchpad, the touchpad may sense that the user presses the touchpad.

FIG. 39 is a three-dimensional graph illustrating a contact pressure calculated by a touchpad at each position when an internal region of 4 cm*2 cm of a touchpad of 6.5 cm*4 cm is touched by a finger (thumb) as shown in FIG. 38. FIG. 39-(A) is a view seen at an angle of 25 degrees from the xy plane. FIG. 39-(A′) is a view seen at an angle of 7 degrees from the xy plane.

FIG. 39-(B) and FIG. 39-(B′) are views seen after the views of FIGS. 39-(A) and 39-(A′) are rotated by 180 degrees about a z axis. In order to display pressures by colors, a colored bar graph is shown on the right side.

In each graph, Sp denotes a contour surface of a pressure value Z obtained when the touchpad is pressed, and St denotes a contour surface of a pressure value obtained when the touchpad is touched. For reference, a Z plane is denoted by S_{c} corresponding to a maximum touch pressure in order to show a relationship between the two contour surfaces Sₚ and Sₜ.

Referring to FIG. 39, since the electrostatic capacity of the touchpad when a right lower surface is pressed is less than the electrostatic capacity of the touchpad when a left upper surface is contacted, inconvenience may be caused when the same pressing reference pressure is set for the whole area of the touchpad.

To solve the problem, a pressing reference pressure may be set for each point on the touchpad.

In detail, in a configuration for the right-handed, the pressing reference pressure of the left upper region may be set to be higher than that for the right lower surface, and in a configuration for the left-handed, a pressing reference pressure of a left lower region may be set to be lower than that for the right upper region of the touchpad.

Such a pressing reference pressure may be set as a default by a manufacture during production, or may be set by a user after purchase.

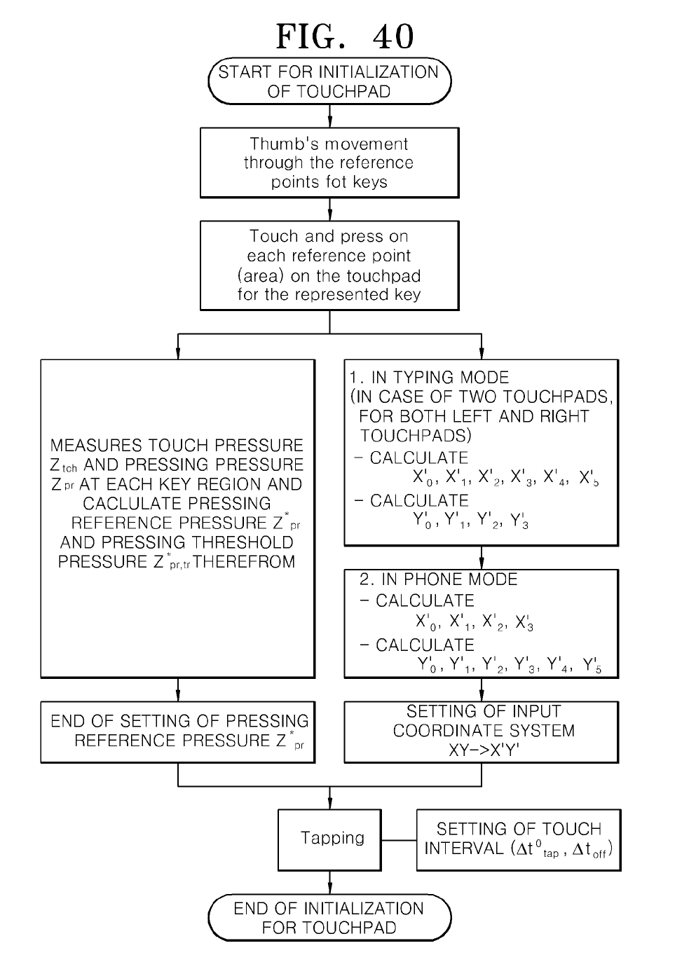

FIG. 40 is a flowchart illustrating a method of setting a pressing reference pressure.

All keys may be pressed and a coordinate system X′-Y′ may be automatically set at the same time as the pressing reference pressure for each key is set, or each setting may be independently performed as shown in FIG. 40.

Referring to FIG. 40, after a pressing reference pressure and the input reference coordinate system is set, the tapping reference time may be set.

This step is performed when a new function needs to be added by using tapping. Since a tapping pattern may be different depending on a user, once the tapping reference time is set in the initialization step, many functions can be performed by tapping, and thus the number of function buttons of a portable digital device can be reduced and ultimately all function buttons may be not be installed. Accordingly, the space occupied by the function buttons can be saved for other elements like display screen, thereby making it possible to increase the size of display screen.

Although it has been explained that the division regions of the touchpad for the keys of the virtual keyboard are fixedly set, they don't have to be fixed. Rather the areas of the division regions may be changed if necessary.

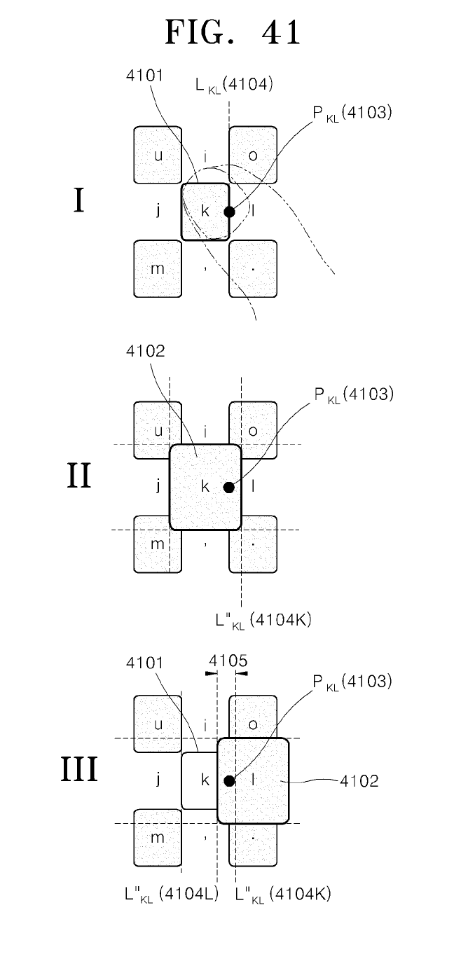

For example, while key regions constituting a virtual keyboard have uniform areas in inactive states, a key region activated by contact with a finger may be expanded to stably input letters, which is shown in FIG. 41.

FIG. 41 illustrates a method of defining each key region of a virtual keyboard. Although all regions have uniform area in inactive states, the region corresponding the activated key is expanded when a finger contacts the area for the key.

That is, all regions have the uniform area 4101. When the center of a finger contacts a key 4102, the key 4102 is activated, and the region 4101 corresponding to the activated key 4102 is expanded to include part of the area for neighboring keys.

That is, it is not simply showing the enlarged key region of the virtual keyboard on a screen, but it is expanding the area of the division region on a sensor unit to which a virtual key is assigned.

Accordingly, the active key region on the touchpad or touchscreen can be enlarged and a finger can be more freely moved in a larger space for the key. In particular, even when a finger is located at a border with adjacent keys, the adjacent keys are not easily activated and a selected active key can be stably maintained and a designated letter can be input.

Also, there is an advantage that change of the contact point which may result in inputting a letter different from what was initially selected to be input by himself/herself can be prevented when a user touches and presses the touchpad for the selected letter on a virtual keyboard to be input.

That is, referring to FIG. 41I, when a finger is located on a point ‘P_{KL}’ 4103 that is on the border line L_{KS} 4104 between keys ‘K’ and ‘L’, although the key ‘K’ is presently activated, ‘L’ may be input instead of ‘K’ with a slight movement of the finger across the border line L_{KS} 4104 which changes the activated key ‘L’ from ‘K’ if there is no expansion of the area for the activated key.

On the contrary, referring to FIG. 41II, when a finger is located on the point ‘P_{KL}’ 4103 and the key ‘K’ is activated, since the area on the touchpad for activated key ‘K’ is actually expanded, a new border line L″_{KL} 4104K is formed. Since an expanded region 4105 should be passed in order to activate the key ‘L’, an accidental activation of an adjacent key due to a slight movement of a finger as shown in FIG. 411 can be prevented.

Likewise, when the key ‘L’ is activated, a new border line L′_{KL} 4104L is formed and the key ‘K’ is deactivated. Such an expanded region enables an activated key to be stably input, but when the expanded region is too large, it may be difficult to select an adjacent key. Accordingly, it is preferable that the expanded region should not exceed the center of an adjacent key region. That is, it is preferable that an expansion ratio be less than 2.

The present invention may be embodied as computer-readable codes on a computer-readable recording medium. The computer-readable recording medium is any data storage device that can store data which can be thereafter read by a computer system. Examples of the computer-readable recording medium include read-only memories (ROMs), random-access memories (RAMs), CD-ROMs, magnetic tapes, floppy disks, optical data storage devices, and carrier waves (such as data transmission through the Internet). The computer-readable recording medium can also be distributed over network coupled computer systems so that the computer readable code is stored and executed in a distributed fashion.

1. A virtual keyboard input system using a pointing device in a digital device, the virtual keyboard input system comprising:
a sensor unit sensing a contact and a two-dimensional contact position;
a switch unit; and
a control unit dividing a contact sensitive region of the sensor unit into multiple division regions according to XY coordinates, assigning virtual keys of a virtual keyboard to the division regions, and when the switch unit is turned on, controlling an input of information for a virtual key assigned to a division region which is contacted among the division regions.

2. The virtual keyboard input system of claim 1, wherein the sensor unit comprises a first sensor unit to which a first virtual key set is assigned and a second sensor unit to which a second virtual key set is assigned.

3. The virtual keyboard input system of claim 2, wherein the switch unit comprises a first switch unit coupled with the first sensor unit to input the first virtual key set and a second switch unit coupled with the second sensor unit to input the second virtual key set.

4. The virtual keyboard input system of claim 1, wherein the switch unit uses a mechanical switch that is turned on by pressing.

5. The virtual keyboard input system of claim 4, wherein the sensor unit is pressed by a user to a predetermined depth, and the switch unit is disposed adjacent to the sensor unit and is also pressed when the sensor unit is pressed.

6. The virtual keyboard input system of claim 1, wherein the sensor unit senses the contact and the contact position by using a change in electrostatic capacity due to contact.

7. The virtual keyboard input system of claim 1, wherein the sensor unit senses the contact and the contact position by using a change in resistance due to contact.

8. The virtual keyboard input system of claim 6, wherein the switch unit comprises:
a lower switch unit disposed on a top surface of the sensor unit and including a group of lines that are arranged in parallel in a first axis; and
an upper switch unit spaced apart from the lower switch unit and including a group of lines that are arranged in parallel in a second axis different from the first axis and contact the first lines of the lower switch unit due to a downward pressure, wherein the switch unit detects a pressing by determining whether current flows when the lower switch unit and the upper switch unit contact each other.

9. The virtual keyboard input system of claim 8, wherein the lines of the lower switch unit include negative power lines connected to a negative electrode, and positive power lines connected to a positive electrode, which are alternately arranged, wherein the second lines of the upper switch unit are conductive lines with no connection with power source.

10. The virtual keyboard input system of claim 1, wherein the switch unit is disposed at an edge of a surface opposite to a surface of the digital device where the sensor unit is disposed such that when a user holds the digital device in one hand and contacts the sensor unit with the thumb, the switch unit can be pressed with other fingers than the thumb.

11. The virtual keyboard input system of claim 1, wherein a switch used in the switch unit is turned on or off in accordance with a change in electrostatic capacity.

12. The virtual keyboard input system of claim 11, wherein the switch unit uses a part of a sensing region of the sensing unit to sense the change in the electrostatic capacity.

13. The virtual keyboard input system of claim 1, wherein uneven members are formed as a guiding element on a surface of the sensor unit to distinguish the division regions.

14. The virtual keyboard input system of claim 1, wherein at least a central row or column of division regions is larger than that of other division areas.

15. The virtual keyboard input system of claim 1, wherein the control unit controls the virtual keyboard realized by the sensor unit to be displayed on a screen of the digital device.

16. The virtual keyboard input system of claim 1, wherein the control unit controls information of a virtual key assigned to a division region which is contacted among the division regions to be displayed on a screen of the digital device.

17. The virtual keyboard input system of claim 1, wherein, when a division region among the division regions of the sensing unit is contacted, the control unit makes the division region to be expanded to have a greater area than that before being contacted.

18. The virtual keyboard input system of claim 1, wherein, when a switch-on time for which the switch unit is turned on is less than a preset time interval, the control unit makes a primary information assigned to the virtual key is input while if the switch-on time is greater than the preset time interval a secondary information which is different from the primary information is to be input.

19. The virtual keyboard input system of claim 18, wherein the secondary information assigned to a virtual key is to input an additional space after the primary information assigned to the virtual key is input.

20. The virtual keyboard input system of claim 18, wherein the secondary information assigned to a virtual key is to input what is to be input when both the virtual key and a shift key are simultaneously pressed.

21. The virtual keyboard input system of claim 1, wherein a position of each of the division regions is calibrated in accordance with a center position of the contacting area of a finger with the division region.

22. A virtual keyboard input system using a pointing device in a digital device, the virtual keyboard input system comprising:
a sensor unit sensing a contact and a two-dimensional contact position in accordance with a change in electrostatic capacity and calculating a contact pressure according to the change in the electrostatic capacity; and
a control unit dividing a contact sensing region of the sensor unit into multiple division regions according to XY coordinates, assigning virtual keys of a virtual keyboard to the division regions, and making information of a virtual key assigned to a division region that is contacted be input when the calculated contact pressure is greater than a pressing reference pressure.

23. The virtual keyboard input system of claim 22, wherein, the control unit makes information of a virtual key assigned to a division region that is contacted while the contact pressure exceeds a pressing threshold pressure, be input, when the contact pressure exceeds the pressing reference pressure, and when a contact position, contacted when the contact pressure exceeds the pressing reference pressure, is different from a contact position, contacted when the contact pressure exceeds the pressing threshold pressure, wherein the pressing threshold pressure is a pressure between the pressing reference pressure and a touch pressure by which a touch is identified.

24. The virtual keyboard input system of claim 22, wherein the sensor unit comprises a first sensor unit to which a first virtual key set is assigned and a second sensor unit to which a second virtual key set is assigned.

25. The virtual keyboard input system of claim 22, wherein uneven members are formed as a guiding element on a surface of the sensor unit to distinguish the division regions.

26. The virtual keyboard input system of claim 22, wherein at least a central row or column of division regions is larger than other division regions.

27. The virtual keyboard input system of claim 22, wherein the control unit controls the virtual keyboard realized by the sensor unit to be displayed on a screen of the digital device.

28. The virtual keyboard input system of claim 22, wherein the control unit controls information of a virtual key assigned to a division region that is contacted among the division regions to be displayed on a screen of the digital device.

29. The virtual keyboard input system of claim 22, wherein, when a division region among the division regions of the sensing unit is contacted, the control unit makes the division region to be expanded to have a greater area than that before being contacted.

30. The virtual keyboard input system of claim 22, wherein, when a switch-on time for which the switch unit is turned on is less than a preset time interval, the control unit makes a primary information assigned to the virtual key is input while if the switch-on time is greater than the preset time interval a secondary information which is different from the primary information is to be input.

31. The virtual keyboard input system of claim 30, wherein the secondary information assigned to a virtual key is to input an additional space after the primary information assigned to the virtual key is input.

32. The virtual keyboard input system of claim 30, wherein the secondary information assigned to a virtual key is to input what is to be input when both the virtual key and a shift key are simultaneously pressed.

33. The virtual keyboard input system of claim 22, wherein a position of each of the division regions is calibrated in accordance with a center position of the contacting area of a finger with the division region.

34. The virtual keyboard input system of claim 22, wherein the pressing reference pressure is set variably depending on a contact position.

35. The virtual keyboard input system of claim 22, wherein, in a first mode for the right-handed, the pressing reference pressure for a left upper region of the sensor unit is set to be higher than the pressing reference pressure for a right lower region of the sensor unit.
